(19) United States
(12) Patent Application Publication
(10) Pub. No.: US 2024/0359574 A1
(43) Pub. Date: Oct. 31, 2024

(54) PLUGGABLE ENCLOSURE TO CONNECT A DISTRIBUTED ENERGY RESOURCE TO A METER SOCKET ADAPTER

(71) Applicant: CONNECTDER, INC., Philadelphia, PA (US)

(72) Inventors: John Schroeder, Falls Church, VA (US); Whitman Fulton, Falls Church, VA (US); Benjamin Lewis, Falls Church, VA (US); Daniel Anthony Falcone, Willow Grove, PA (US)

(73) Assignee: CONNECTDER, INC., Philadelphia, PA (US)

(21) Appl. No.: 18/766,647

(22) Filed: Jul. 8, 2024

Related U.S. Application Data
(63) Continuation-in-part of application No. 17/307,426, filed on May 4, 2021.
(63) Continuation-in-part of application No. 17/663,362, filed on May 13, 2022.
(60) Provisional application No. 62/986,025, filed on Mar. 6, 2020.
(60) Provisional application No. 63/223,732, filed on Jul. 20, 2021.

(51) Int. Cl. B60L 53/16; B60L 53/62; B60L 53/66; H02J 7/00

(52) U.S. Cl. CPC B60L 53/16; B60L 53/62; B60L 53/66; H02J 7/00034; H02J 7/0029; H02J 2310/48

(57) ABSTRACT

A system includes a meter socket adapter (MSA) to electrically connect a meter socket and a utility meter, electrical contacts to electrically connect the MSA to the meter socket and the utility meter, and a data circuit to measure an electrical load through the MSA, and a pluggable assembly coupled to the MSA, the pluggable assembly including a housing to be coupled to the MSA housing, at least one of a set of power interface connectors extending from the housing into the MSA housing to connect to the MSA electrical contacts and a data interface connector extending from the housing to removably connect to the MSA data circuit, and at least one of an electrical circuit interface to electrically connect the set of power interface connectors to the electrical circuit and a data circuit interface to electrically connect the data interface connector to the data circuit.

### CROSS REFERENCE TO RELATED APPLICATIONS

The present application is a continuation-in-part of U.S. application Ser. No. 17/307,426 filed May 4, 2021 which claims priority to U.S. Provisional Application No. 62/986,025 filed Mar. 6, 2020, which applications are incorporated herein by reference in their entireties. The present application is a continuation-in-part of U.S. application Ser. No. 17/663,362 filed May 13, 2022 as well, which claims priority to U.S. Provisional Application No. 63/223,732 filed Jul. 20, 2021, both of which are incorporated herein by reference in their entireties.

### TECHNICAL FIELD

The embodiments described and recited herein pertain, generally, to behind-the-meter electrical power management.

### BACKGROUND

Electric vehicles (EVs) utilize battery packs, which include electrical energy storage systems that provide energy to power the vehicle and its accessories. The energy storage system corresponding to some EVs may be utilized for other purposes external to the EV itself, including powering small loads from appliances, powering site-level loads, or even returning power to the utility electric grid.

Distributed energy resources (DER) are power sources that can be aggregated to provide power necessary to meet regular demand. As the electric grid continues to modernize, DERs such as photovoltaic solar panels, wind turbines, electric vehicles, energy storage batteries and advanced renewable technologies and the related electrical service equipment can help facilitate the transition to a smarter grid.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure are directed to a pluggable assembly to electrically connect a meter socket adapter (MSA) and an electrical circuit, the pluggable assembly including a housing, a set of power interface connectors extending from the housing to electrically connect to the MSA, an electrical circuit interface to electrically connect the set of power interface connectors to the electrical circuit.

In some implementations, the pluggable assembly includes a data interface connector extending from the housing to electrically connect to the MSA, wherein the data interface connector transmits data between the MSA and external electrical equipment. In some implementations, the set of power interface connectors are configured to removably couple the pluggable assembly to the MSA. In some implementations, the electrical circuit is electrically connected to a distributed energy resource (DER). In some implementations, the set of power interface connectors are symmetrical to allow for the pluggable assembly to be pluggably coupled to the MSA in different orientations. In some implementations, the electrical circuit interface includes an electrical conduit. In some implementations, the electrical circuit interface includes a circuit breaker within the housing. In some implementations, the housing includes one or more of a hasp, clip, or latch for securing the pluggable assembly to the MSA.

Aspects of the present disclosure are directed to a pluggable assembly to electrically connect a meter socket adapter (MSA) and a communications circuit, the pluggable assembly including a housing, a data interface connector extending from the housing to electrically connect to the MSA, and a data circuit interface to electrically connect the data interface connector to the communications circuit the data circuit interface to provide load measurements from the MSA to the communications circuit.

In some implementations, the load measurements include at least one of voltage, current, and power. In some implementations, the data circuit interface is configured to provide a control signal from the communications circuit to the MSA to cause the MSA to actuate a switch. In some implementations, the pluggable assembly includes a set of metal prongs extending from the housing, the set of metal prongs to pluggably attach the pluggable assembly to the MSA. In some implementations, the communications circuit is electrically connected to a distributed energy resource (DER). In some implementations, the data interface connector is symmetrical to allow for the pluggable assembly to be pluggably coupled to the MSA in different orientations. In some implementations, the housing includes one or more of a hasp, clip, or latch for securing the pluggable assembly to the MSA.

Aspects of the present disclosure are directed to a system including a meter socket adapter (MSA) configured to electrically connect a meter socket and a utility meter, the MSA including an MSA housing, electrical contacts to electrically connect the MSA to the meter socket and the utility meter, and a data circuit to measure an electrical load through the MSA, and a pluggable assembly configured to be removably coupled to the MSA, the pluggable assembly including a pluggable assembly housing configured to be coupled to the MSA housing, at least one of a set of power interface connectors extending from the pluggable assembly housing into the MSA housing to removably connect to the electrical contacts of the MSA and a data interface connector extending from the pluggable assembly housing to removably connect to the data circuit of the MSA, and at least one of an electrical circuit interface to electrically connect the set of power interface connectors to the electrical circuit and a data circuit interface to electrically connect the data interface connector to the data circuit.

In some implementations, the electrical circuit is connected to a distributed energy resource (DER). In some implementations, the set of power interface connectors and the data interface connector are symmetrical to allow for the pluggable assembly to be removably coupled to the MSA in different orientations. In some implementations, the electrical circuit interface includes an electrical conduit, and wherein the data circuit interface includes a wire separate from the electrical conduit. In some implementations, the electrical circuit interface includes wire terminations to electrically connect the set of power interface connectors to the electrical circuit. In some implementations, the pluggable assembly housing includes one or more of a hasp, clip, or latch for securing the pluggable assembly to the MSA housing. In some implementations, the electrical circuit interface is electrical connected to a distributed energy resource (DER), and wherein the communications circuit is electrically connected to the DER. In some implementations, the pluggable assembly includes a circuit breaker within the MSA housing or the pluggable assembly housing.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different FIGS. indicates similar or identical items.

FIG. 1 shows a schematic drawing of a power distribution system, in accordance with at least one example embodiment described and recited herein;

FIG. 2 shows a schematic drawing of a power distribution system, in accordance with at least one example embodiment described and recited herein;

FIG. 3 shows a schematic drawing of an energy storage system, in accordance with at least one example embodiment described and recited herein;

FIG. 4 shows a schematic drawings of an energy storage system, in accordance with at least one example embodiment described and recited herein;

FIG. 5 shows a schematic drawings of an electrical path corresponding at least one example embodiment of a weatherized energy storage system as described and recited herein;

FIG. 6 shows a schematic drawings of a wireless communications path corresponding at least one example embodiment of an energy storage system as described and recited herein;

FIG. 7 shows a schematic drawing of the electric vehicle charger interface, in accordance with at least one example embodiment described and recited herein;

FIG. 8 shows a single line schematic drawing of the electric vehicle charger interface, in accordance with at least one other example embodiment described and recited herein;

FIG. 9 shows a schematic drawing of a socket adaptor in accordance with at least one example embodiment described and recited herein;

FIG. 10 shows a schematic drawing of a socket adaptor in accordance with at least one other example embodiment described and recited herein;

FIG. 11 shows an operation flow, in accordance with at least one example embodiment described and recited herein;

FIG. 12A shows a schematic diagram of an override component, in accordance with at least one example embodiment described and recited herein;

FIG. 12B shows a schematic diagram of the override reset actuator of FIG. 12A, in accordance with at least one example embodiment described and recited herein;

FIG. 12C also shows a schematic diagram of the override reset actuator of FIG. 12A, in accordance with at least one example embodiment described and recited herein;

FIG. 13 shows an operational flow for implementing an override, in accordance with at least one example embodiment described and recited herein;

FIG. 14A shows a side view of an adaptor, in accordance with at least one example embodiment described and recited herein;

FIG. 14B shows a front view of an adaptor, in accordance with at least one example embodiment described and recited herein;

FIG. 14C shows a review of an adaptor, in accordance with at least one example embodiment described and recited herein;

FIG. 15A shows a top view of an adaptor interface, in accordance with at least one example embodiment described and recited herein;

FIG. 15B shows a bottom view of an adaptor interface, in accordance with at least one example embodiment described and recited herein;

FIG. 16A shows a side view of a socket adaptor, in accordance with at least one example embodiment described and recited herein;

FIG. 16B shows a planar view of a socket adaptor, in accordance with at least one example embodiment described and recited herein;

FIG. 17 shows a side view of an adaptor interface, in accordance with at least one example embodiment described and recited herein;

FIG. 18 shows a wireless adaptor interface, in accordance with at least one example embodiment described and recited herein;

FIG. 19A shows a side view of an adaptor interface, in accordance with at least one other example embodiment described and recited herein;

FIG. 19B shows components of the adaptor interface of FIG. 19A, in accordance with at least one example embodiment described and recited herein;

FIG. 20A shows a mating of a socket adaptor and adaptor interface, in accordance with at least one example embodiment described and recited herein;

FIG. 20B shows the mated socket adaptor and adaptor interface of FIG. 20A, in accordance with at least one example embodiment described and recited herein;

FIG. 21A shows a configuration of the adaptor interface, in accordance with at least one example embodiment described and recited herein;

FIG. 21B shows another configuration of the adaptor interface, in accordance with at least one example embodiment described and recited herein;

FIG. 22A shows another configuration of an adaptor interface, in accordance with at least one example embodiment described and recited herein; and

FIG. 22B shows another configuration of the adaptor interface of FIG. 22A, in accordance with at least one example embodiment described and recited herein.

FIG. 23 shows a schematic drawing of a power distribution system, in accordance with at least one example embodiment described and recited herein;

FIG. 24 shows a schematic drawing of a power distribution system, in accordance with at least one example embodiment described and recited herein;

FIG. 25 shows a schematic drawing of a method for controlling reconnecting the co-located electric equipment, in accordance with at least one example embodiment described and recited herein;

FIG. 26 shows a schematic drawings of an energy storage system, in accordance with at least one example embodiment described and recited herein;

FIG. 27 illustrates an upper perspective view of a system including a pluggable assembly and a meter socket adapter in accordance with at least one example embodiment described and recited herein;

FIG. 28 illustrates a lower perspective view of the system of FIG. 27 in accordance with at least one example embodiment described and recited herein;

FIG. 29 illustrates an upper perspective view of the system of FIG. 27 with the pluggable assembly coupled to meter socket adapter in accordance with at least one example embodiment described and recited herein; and

FIG. 30 illustrates a cutaway view of the system of FIG. 27 in accordance with at least one example embodiment described and recited herein.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to a Meter Socket Adapter (MSA) that facilitates the connection of one or more bidirectional distributed energy resources (DERs) to a building, such as a home. The MSA may include an embedded Energy Management System (EMS) or power control system (PCS). Discussion of functionality provided by the EMS may apply to a PCS as well. The EMS may oversee, monitor, orchestrate, and/or perform core safety functions including, but not limited to, protecting the meter, meter socket, and service entrance conductors from potential overcurrent due to the combined loads associated with the building and one or more DER circuits. The EMS may perform other functions including isolating the building from the utility grid during an outage, to allow for DER-based microgrid operation. In an example, DER-based microgrid operation may include operating a microgrid including a solar photovoltaic (PV) system and an Energy Storage System (ESS). Isolating the building from the utility grid may prevent inadvertent energy backfeed to the grid. The EMS may isolate the building from the utility grid while the grid is functional to allow for the building to consume power from the one or more DERs. The EMS may isolate the building from the grid in an energy arbitrage operational mode to optimize consumption of power from the grid and/or production of power to the grid.

The EMS may protect the service from overcurrent using a combination of hardware and software. The software may be embedded class B control software. The hardware may include a switch (relay) for the DER circuit. The switch may be a 100 k cycle rated switch. Circuit board and/or control logic may operate the switch based on measured instantaneous and continuous current, relative to the rating of the electrical service. The circuit board and/or control logic may directly operate an integrated whole-building disconnect switch. The whole-building disconnect switch may be a Microgrid Interconnect Device (MID) or Automatic Transfer Switch (ATS). The whole-building disconnect switch may isolate the building from the utility grid during an outage, and safely reconnect the building upon restoration of grid power.

The whole-building disconnect switch may conduct logic checks, including but not limited to voltage, current, and frequency measurement. The logic checks may allow for safe third-party synchronous operation of the integrated whole-building disconnect switch, third-party dynamic load balancing/throttling on the one or more DER circuits, or other power control/energy management functions. Third-party operation of the whole-building disconnect switch cannot override embedded safety based logic rules. For example, the whole-building disconnect switch cannot reclose into a lack of utility voltage. The whole-building disconnect switch may conduct a logic check to determine a voltage at the utility before allowing for connection to the utility grid.

The circuit board and/or control logic may send or receive information and/or command and control signals based on the logic checks to third-party equipment. Third-party equipment may include, for example, solar inverters, battery based energy storage systems (BESS), and electric vehicles (EV), via a separate but internal to the MSA communications module. Data transmission between the communications module and third-party equipment may be in a variety of forms, such as ModBus, CANbus, power line communications (PLC), ethernet, WIFI, or other communications protocol. Any failure of such data transmission may disallow third-party control of the whole-building disconnect switch. An externally accessible, manual reclose switch for the whole-building disconnect switch may be operated in the event the embedded EMS fails to reclose upon restoration of grid power. The controlled DER circuit switch will not reclose until the EMS becomes functional and conducts logic checks, to ensure no inadvertent backfeed of power to the grid, should the manual reclose switch be operated while the grid is still down.

The MSA may provide safe interconnection between the utility grid, the building, and the one or more DERs. The MSA may open and/or close the whole-building disconnect. The MSA may provide data provision for data from the one or more DERs, the utility, and/or the building. The MSA may provide these functions, and other self-contained functions, irrespective of the generation, load, or data connection between the MSA and any co-located peripheral devices.

Aspects of the present disclosure are directed to a pluggable assembly (e.g., pluggable junction box, pluggable enclosure) that is configured to be removably attached to the MSA to provide a pluggable interface for power and/or data connections between the MSA and co-located peripheral devices (e.g., DERs). The pluggable assembly may be configured to plug into the MSA (using power and/or data connectors) in different orientations, allowing for flexibility in installation. Furthermore, the pluggable assembly can be installed and removed without tools, as the pluggable assembly can be plugged into the MSA and unplugged from the MSA by hand. To secure the pluggable assembly to the MSA, the pluggable assembly may include a clip, a hasp, and/or latch, such that the pluggable assembly can be removed by hand without the use of tools. The pluggable assembly can be removed under load, with safety mechanisms to reduce a risk to an individual who is removing the pluggable assembly under load. A connection between the power connectors of the pluggable assembly and receptacles of the MSA can be load-break rated. In some implementations, the pluggable assembly and/or the MSA includes a circuit breaker to reduce a risk of shock in the event the pluggable assembly is removed under load. Thus, the pluggable assembly provides a versatile, easily installed power and/or data connection between the MSA and co-located peripheral devices, such as DERs.

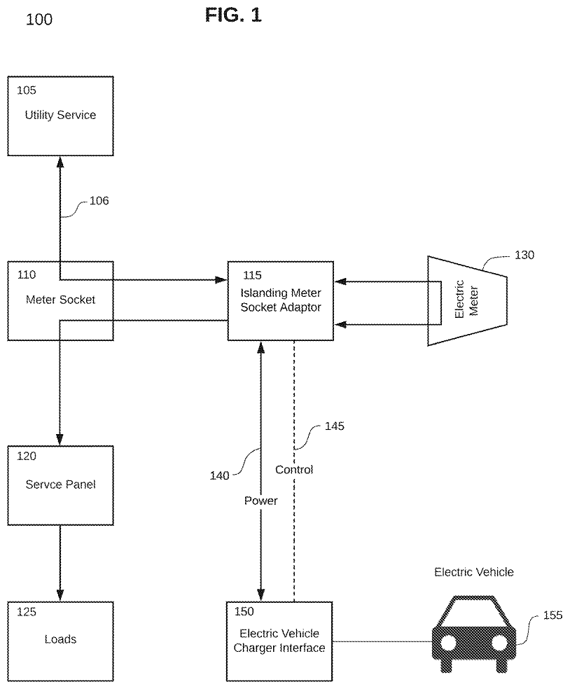

FIG. 1 shows a schematic drawing of a power distribution system, in accordance with at least one example embodiment described and recited herein. As depicted, system 100 includes, at least, utility service 105, meter socket 110, islanding meter socket adaptor 115, service panel 120, loads 125, electric meter 130, electric vehicle charger interface 150, and electric vehicle 155.

Utility service 105 may refer to a public utility distribution system that supplies two-phase power via a meter to a customer.

Meter socket 110 may refer to a socket having utility-side contacts to interface with utility service 105 and customer-side contacts to electrically connect to a customer's private distribution system, e.g., islanding meter socket adaptor 115 and service panel 120.

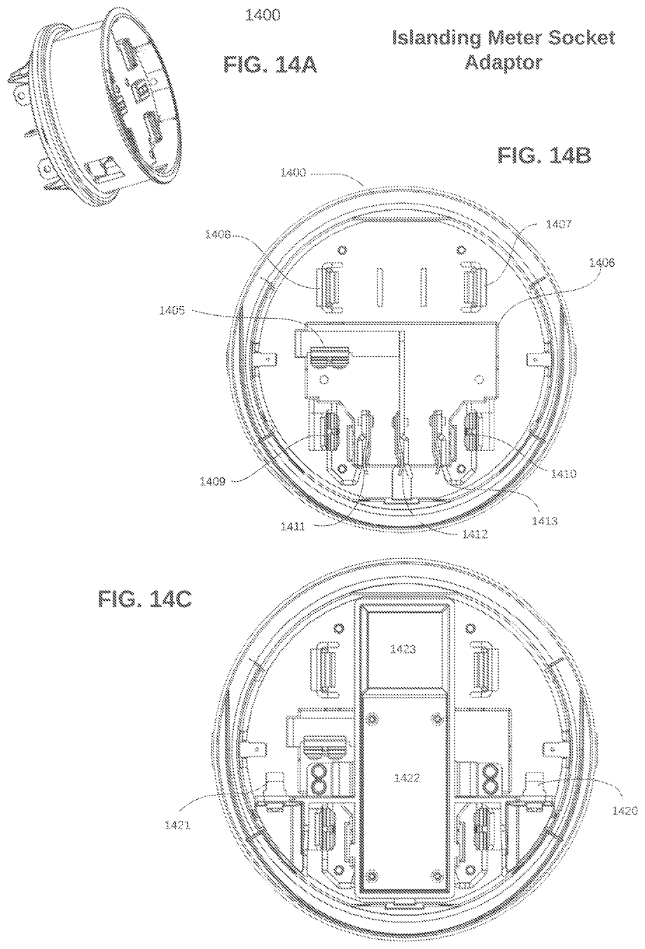

Islanding meter socket adaptor 115 may refer to a device depicted in FIG. 14A that plugs into the meter socket 110 and resides between the meter socket and electric meter 130.

Service panel 120 may refer to the main service panel that provides a distribution point for the customer's loads 125. This panel usually contains circuit protection devices and terminal points that enable the distribution of power through the private facility.

Loads 125 may refer to the typical loads found in a private facility. Some examples of typical loads include, but not limited to, electric appliances, air conditioners, electric hot water heaters, and electric outlets.

Electric meter 130 may refer to a power metering device that plugs into the Islanding meter socket adaptor 115. Electric meters are typically utilized to monitor the power consumption or production at a Utility customer's facility for the purpose of billing for the utility service.

Electric vehicle charger interface 150 may refer to a charger interface that may interact with islanding meter socket adaptor 115 to safely enable an electric vehicle 155 to connect to the load side of meter socket 110. In accordance with at least one example embodiment described and recited herein, electric vehicle charger interface 150 resides onboard electric vehicle 155 to reduce the number of external enclosures needed for system 100. Alternative form factors include separate enclosures that house EV car chargers or other multi source backup inverters.

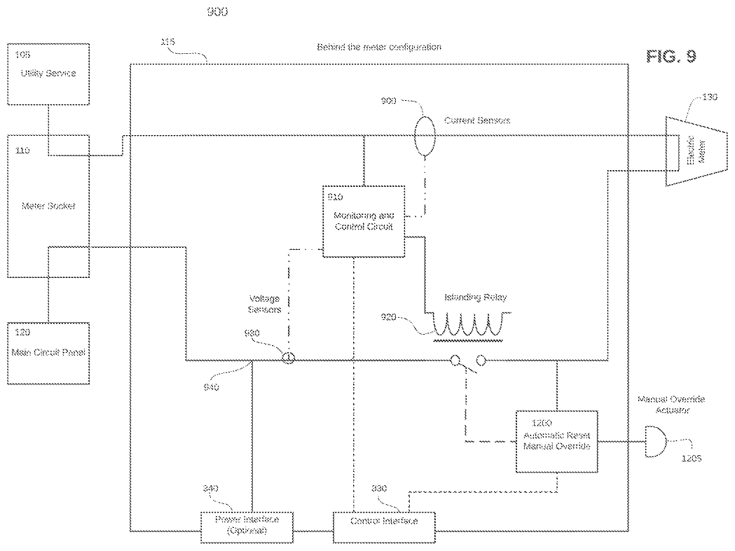

In accordance with one example operational flow, as described and recited herein, power may be supplied to electric vehicle charger interface 150, via utility service 105, meter socket 110, islanding meter socket adaptor 115, and wires 140; and communications in the form of digital or analog signals from, e.g., monitoring and control circuit 910 (see FIG. 9), to enable or disable the connection of the electric vehicle backup source 155 may supplied be to electric vehicle charger interface 150 via wires 145. In addition, control interface 145 may communicate with the electric vehicle inverter 155 to modify the inverters parameters including, but not limited to, power output level or power factor compensation.

In accordance with at least one example implementation, power may be routed directly from load 125 side of islanding meter socket adaptor 115 to electric vehicle charger interface 150. In accordance with at least one additional or alternative implementation, electric vehicle 155 may supply power to the grid or to loads 125. The aforementioned implementations may be enacted depending on program settings, determined by the local utility regulations and end user inputs, programed into the monitoring and control circuit (see FIG. 9).

In accordance with a non-limiting example implementation, in the event of a grid outage, islanding meter socket adaptor 115 may be configured to disconnect from the grid, i.e., utility service 100, while maintaining an electrical connection to electric vehicle charger interface 150 as well as electric vehicle 155 and to service panel 120, thereby supplying power from electric vehicle 155 to loads 125. Islanding meter socket adaptor 115 may be configured to inform the electrical vehicle charger interface 150 that the islanding relay contacts are open by sending a signal over the control interface 145. Accordingly, electrical vehicle charger interface 150 may enable the grid forming power 740 supply by switching the grid forming switch 715 to the electric vehicle grid forming interface 740 position to energize the power connection and pick up the service panel loads 125.

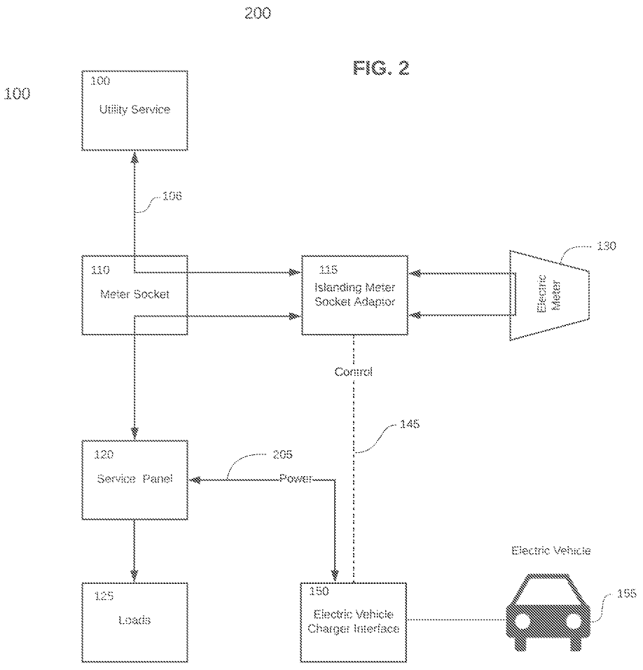

FIG. 2 shows a schematic drawing of a power distribution system, in accordance with at least one other example embodiment described and recited herein. As depicted, similar to system 100, system 200 includes, at least, utility service 105, meter socket 110, islanding meter socket adaptor 115, service panel 120, loads 125, electric meter 130, electric vehicle charger interface 150, and electric vehicle 155.

In accordance with at least one example embodiment, power lines 200 electrically connect charger interface 150 and service panel 120. In at least one example implementation, charger interface supports charging of electric vehicle 155 as well as, in accordance with at least one additional or alternative implementation, discharging of electric vehicle 155 to supply power to loads 125 or to feed power back to utility service 105, i.e., the grid. That is, in the event of a power outage, a relay for meter socket adaptor may open to disconnect all downstream components from the grid, thus enabling EV 155 to provide backup power to loads 125.

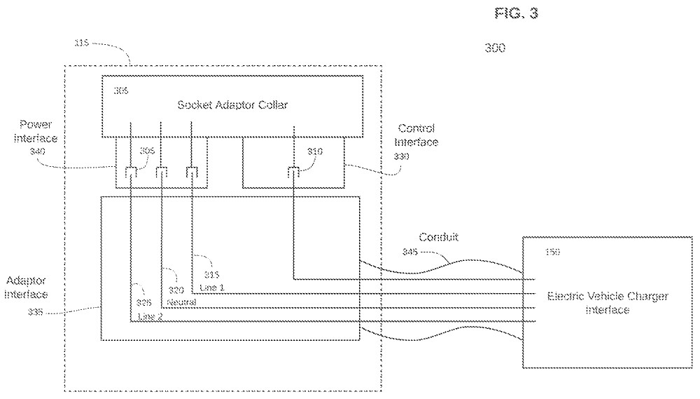

FIG. 3 shows a schematic drawing of an energy storage system, in accordance with at least one example embodiment described and recited herein. That is, FIG. 3 shows islanding meter socket adaptor 115 interconnected at a site with electrical loads on a grid side circuit interconnection point, with power flowing between the grid, the site, and the energy storage system.

System 300 includes islanding meter socket adaptor 115 electrically connected to electric vehicle charger interface 150. As depicted, islanding meter socket adaptor 115 includes, at least, socket adaptor collar 305, control interface 330, adaptor interface 335, power interface 340, and conduit 345.

Adaptor interface 335 houses the mating connectors for the power and control interfaces which may be electrically connected to socket adaptor collar 305, via power interface 340, which may have plug type connectors for, e.g., AC power Line 1 (315), Line 2 (325), and Neutral (320).

Socket adaptor collar 305 may be implemented as a meter socket adaptor depicted in FIG. 14A. The meter socket adaptor houses the islanding relay 920 and, when mounted in meter socket 110, facilitates its insertion between the utility service 100 and the service panel 120 and further provides a location for the backup power supply connection facilitated by the mating of the adaptor interface 335 and power interface 340.

Control interface 330 may be integrated with the islanding meter socket adaptor 115 collar and houses the connectors used to route the control IO signals from the islanding meter socket adaptor 115 collar to the adaptor interface 335 through the connections 310. This communication is used to control the grid forming switch 715. In addition, the communications may control EV backup source 155 to vary its output based upon desired system setpoints. The communications may be implemented in many forms including but not limited to digital IO, analog IO, and industrial standard serial protocols.

Power interface 340 may be configured to house pluggable connectors 305 designed to pass backup power to the socket adaptor collar 305. These connectors are appropriately sized to pass voltage and current required for the backup power level. Typical electric vehicle backup sources could provide up to 24,000 Watts or more of power to the private facility. For a 240 Volt service this would require connectors capable of carrying up to 100 amps of current.

Conduit 345 may be provided to facilitate AC power connectivity between islanding meter socket adaptor 115 and electric vehicle charger interface 150.

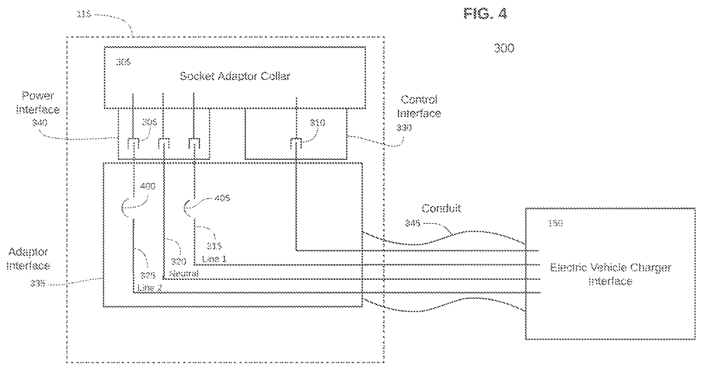

FIG. 4 shows a schematic drawing of an alternative embodiment of 300, in accordance with at least one other example embodiment described and recited herein.

As depicted in FIG. 4, system 300 further includes circuit breakers 400 and 405 that are integrated into the adaptor interface 335 providing circuit protection. Since socket adaptor 115 facilitates a power connection directly to utility service entrance ate the meter socket 110, circuit protection is provided between the service entrance connection 110 and the electric vehicle backup source 155 as close as practical to the service entrance at the meter socket 110. The adaptor interface 335 is a convenient location to place this circuit protection since it is close to the service entrance and it can be easily replaced if needed. The circuit protection can consist of, but is not limited to, circuit breaks or fuses rated for the power flow being provided by the backup source.

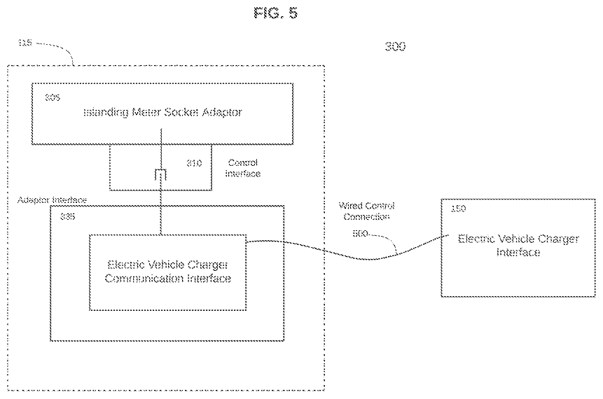

FIG. 5 shows a schematic drawings of an electrical path corresponding at least one example embodiment of system 300, as described and recited herein.

As depicted in FIG. 5, system 300 includes islanding meter socket adaptor 115 electrically connected to electric vehicle charger interface 150. As depicted, islanding meter socket adaptor 115 includes, at least, socket adaptor collar 305, control interface 330, adaptor interface 335, power interface 340, and conduit 345.

Control interface 310 may facilitate an electrical connection between islanding meter socket adaptor 305 and electrical vehicle charger communication interface 335. Control interface 310 is the connection point for IO signals that inform electrical vehicle charger interface 150 of the islanding relay status and interactively communicate with the EV backup supply 155. This connection may be made with a multi-pin low power signaling connector. Low power electrical signals are typically below the thresholds for limited power circuits as defined by the National Electric Code (NEC).

Wired control connection 500 is one method for establishing a signaling connection between electric vehicle charger communication interface 335 and electric vehicle charger interface 150. Wired control connection 500 may carry IO signals and communication traffic between the monitoring and control circuity 910 to electrical vehicle charger interface 150.

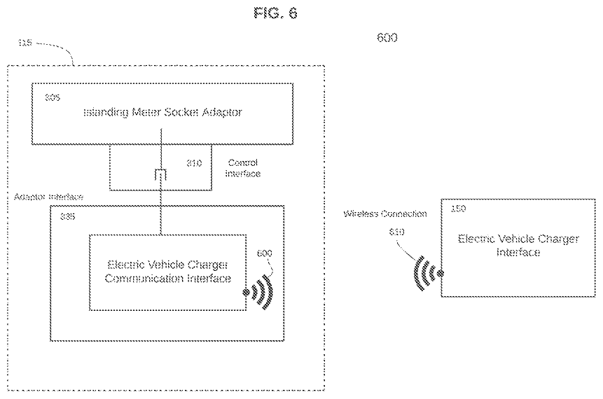

FIG. 6 shows a Schematic drawing of an alternative embodiment of system 300, as described and recited herein.

As depicted in FIG. 6, system 300 further includes wireless communications path 610 to 600 between electric vehicle charger communication interface 335 and electric vehicle charger interface 150. Further, control interface plug 310 may be provided to electrically connect islanding meter socket adaptor 305 and electric vehicle charger communication interface 335. Wireless communications protocols implemented between wireless interfaces 600 and 610 may include, but not be limited to, Wi-Fi, PLC, BPL, etc.

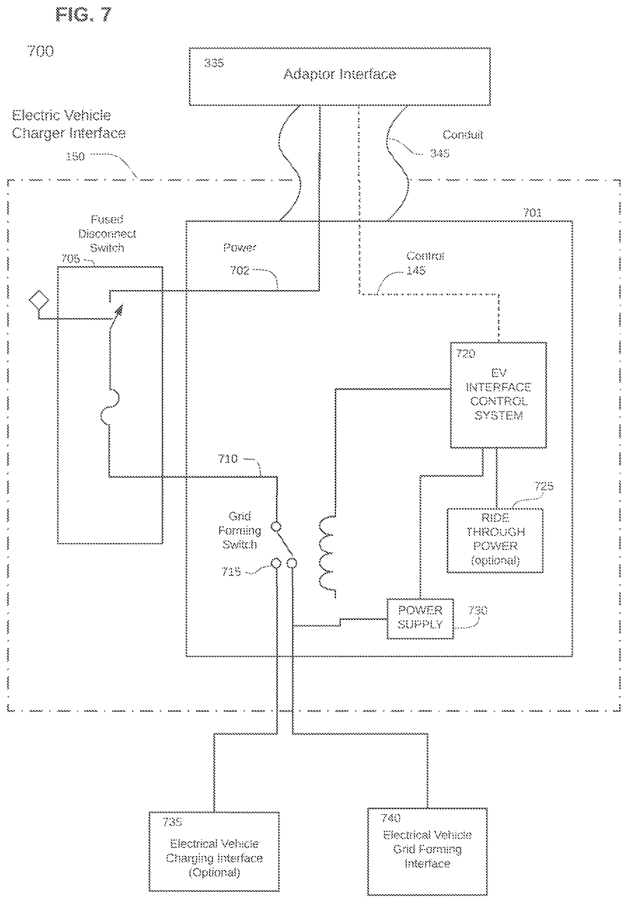

FIG. 7 shows a schematic drawing of the electric vehicle charger interface, in accordance with at least one example embodiment described and recited herein.

Electric vehicle charger interface 150 may be configured or designed to switch between normal grid-based vehicle charging and electrical vehicle-to-grid, or other backup power sourcing, protocols. Electrical vehicle charger interface 150 may reside in a separate enclosure that provides the interconnection between islanding meter socket adaptor 115 and the electric vehicle. The electrical vehicle charger interface houses the components needed to transfer the power connection to the grid forming interface in the event of a utility power outage.

As depicted in FIG. 7, electric vehicle charger interface 150 may include fused disconnect switch 705, grid forming switch enclosure 701, which houses the grid forming switch 715, electric vehicle interface control system 720, ride-through power 725, power supply 730. The electric vehicle charger interface provides terminal connections for the electric vehicle charging interface 735, and electric vehicle grid-forming interface 740.

Based on data regarding grid power status received via adaptor interface 115, electric vehicle charger interface 150 may operate internal grid forming switch 715 to charge electric vehicle 155; alternatively, based on the data regarding grid power status received via adaptor interface 115, electric vehicle charger interface 150 may operate internal grid forming switch 715 to switch to islanding mode to for devices capable of operating in islanding mode.

As referenced in the description and recitation herein, islanding may refer to the disconnection of the service panel 120 from a utility service such that the service panel 120 may be energized from EV backup source 155 through the islanding meter socket adaptor 115 without back feeding power onto the utility service.

Electric vehicle charger interface 150 may be powered either by power supply 730, which may be electrically connected to the electric vehicle grid forming interface 740, or by ride through power 725 located in the electric vehicle charger interface. Ride though power 725 may be included with the electric vehicle charger interface 150 to power the EV Interface Control system in the event that there is no utility or backup power and it is desired to keep the control system powered for status communications or indications. In this regard, vehicle charger interface electric vehicle charger interface 735 also includes fused disconnect switch 705, which provides circuit protection for the service entrance conductors 106 and additionally gives a visible disconnect for service personnel to open in for system maintenance.

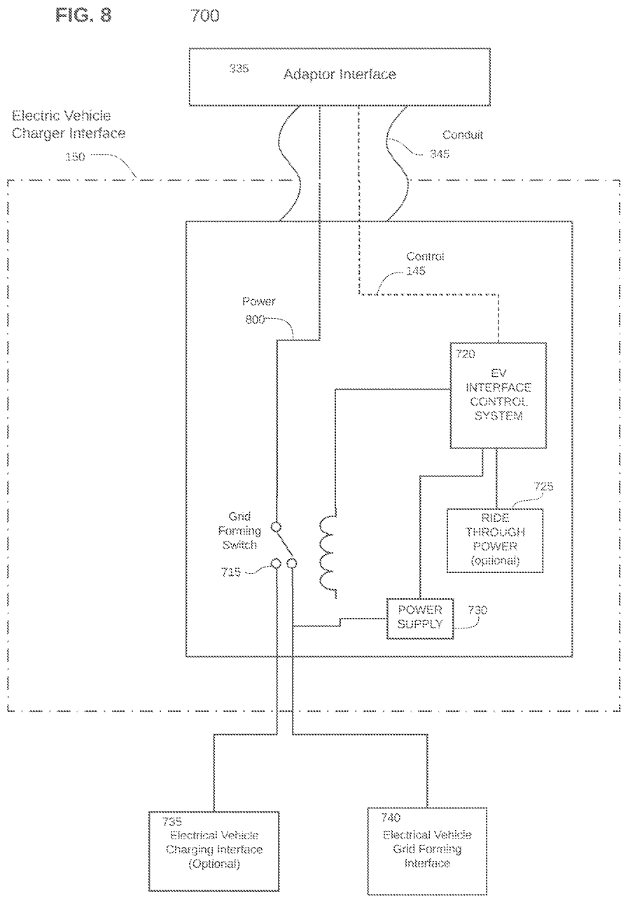

FIG. 8 shows schematic drawing of an alternative embodiment of electric vehicle charger interface 700, in accordance with at least one other example embodiment described and recited herein.

As depicted in FIG. 8, system 700 does not include a fused disconnect switch. Accordingly, the fusing means would be integrated into the Adaptor Interface as shown in FIG. 4. By incorporating the circuit protection in adaptor interface 335, the fusible disconnect is no longer needed, thus reducing a number of components in the system.

FIG. 9 shows a schematic drawing of a socket adaptor in accordance with at least one example embodiment described and recited herein.

FIG. 9 depicts what may be referred to, as a non-limiting example, an islanding meter socket adaptor (IMSA), in accordance with a “behind the meter” (BTM) configuration.

As referenced herein, behind the meter refers to a configuration by which islanding relay 920 is located on a common electric side of electric meter 130 as main service panel 120. Accordingly, main service panel 120 may be electrically isolated from utility service 105, and thus power may be supplied through power interface 340 to supply loads wired into the main service panel 120. While islanding relay 920 may be open, power supplied through power interface 340 is not metered by electric meter 130. In this configuration, the backup source is usually provided by the facility owner and the generated power should not be recorded or billed by the utility. In addition, the backup power will not energize utility service 105, ensuring safety of maintenance personnel that may be handling components at utility service 105 during a utility power outage.

Islanding meter socket adaptor (hereafter “IMSA”) 115 may couple electrically with meter socket 110 and also couple electrically with electric meter 130. Utility power may flow from utility service 105 to the meter socket 110, to IMSA 115, through electric meter 130, through islanding relay 920, to meter socket 110, and ultimately to the service panel 120 to power the connected loads. The islanding relay 920 is a latching relay that disconnects the utility power lines from the main service panel thus electrically islanding the main service panel from the utility service. Power can also flow in either direction from the adaptor interface 335 through power interface 340 to the power interconnection point 940. If a load is connected to the power interface, power will flow out of interconnection point 940 to supply the load. For example, a car charger will consume power to charge the electric vehicle batteries. If a power source is connected to the power interface, the power can flow into connection point 940. For example, a backup generator can source power that will flow into the connection point and supply the service panel loads.

The IMSA 115 contains a monitoring and control circuit 910 that operates in concert with other control logic accessed through the control interface 330 to operate the islanding relay 920 in accordance with the logic depicted in FIG. 11. The control circuit's 210 power supply is auctioneered, meaning whichever power source is energized may power the circuit, whether the utility service inlet and the control interface 225 power line. This allows the control circuit to operate when either utility power 100 or the EV grid forming source 600 is online. In addition to controlling the relay, monitoring and control circuit 910 measures current sensors 900 and voltage sensors 930 to provide input into the control logic for operation of islanding relay 920 and information for auxiliary functions such as, but not limited to, controlling the power output of the EV backup source 155.

If control circuit 910 fails, the islanding relay 920 has the capability to be overridden by a manual override actuator 1205 which is externally accessible on the IMSA. The IMSA also contains an Automatic Reset Manual Override (ARMO) 1200 that will open and disable the manual override of the islanding relay 920. The ARMO 1200 only allows the islanding relay 920 to be overridden shut when both the electric vehicle power source is disconnected from the adaptor interface 335 and power is present on the utility service 100. This is an additional safety feature to prevent the Utility service 100 from being energized through the adaptor interface 335 when there is a power outage and maintenance is being performed on the utility system. The ARMO 1200 is totally separate from the control circuit 910 and is powered by the utility line so it will not be affected by a failure in the control circuit 910. The ARMO 1200 also provides override status to the control system for use in the control logic.

In addition to monitoring the current flowing from the Utility service 100, the Current sensors 900 can provide circuit protection for the service entrance components. When power is being supplied to the standard main service panel 120 and to an additional load through the power interface 340 it is possible to overload the meter socket 110 and utility service 100 drop. Typically, standard service panels include a main circuit protection device that are sized to the maximum service drop rating. In the event that the main service panel 120 draws the maximum amount of power from the service drop and an additional load is then connected to the interface adaptor power interface 340, the standard meter socket adaptor 110 is in danger of being overloaded. In this case, the current sensors 900 are used to detect the total load being serviced by the utility service 110. If the load rating is exceeded the monitoring and control circuit 910 will either disconnect the additional load by opening the grid forming switch 715 or send a signal to the load to reduce its draw such that the total draw is below the utility service rating.

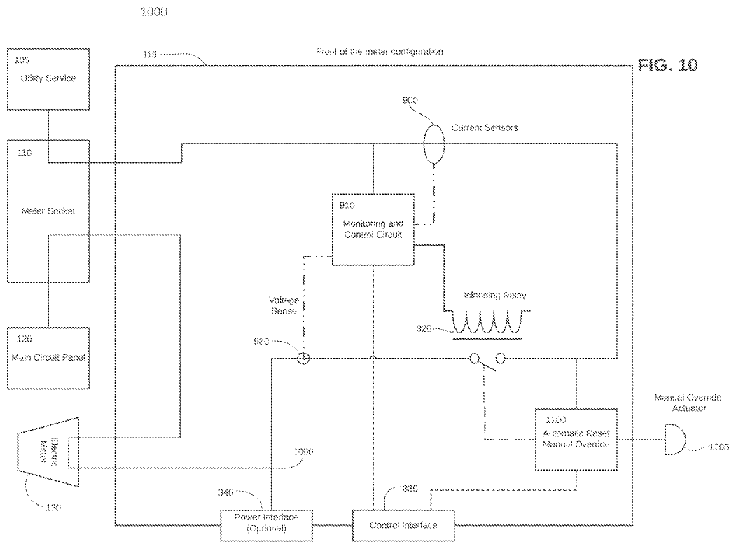

FIG. 10 shows a schematic drawing of a socket adaptor in accordance with at least one other example embodiment described and recited herein depicts the IMSA in the Front of The Meter (FTM) configuration. The components are essentially the same as the system depicted in FIG. 9 with the exception that the standard electric meter 130 is located on the other side of the islanding relay 920. This allows the power interface 340 to be connected to the utility service 100 side of the electric meter 130. This configuration is typically used when the power supply providing energy through the power interface 340 is considered a utility asset that can be metered through the standard electric meter 130 when the islanding relay 920 is open.

FIG. 11 shows an operation flow, in accordance with at least one example embodiment described and recited herein. The flow pertains to the resiliency logic used to operate the relays in the IMSA 115 and electric vehicle charger interface 150. This logic enables the safe application of electric vehicle grid forming power in the event of a utility power failure. It also prevents the power interface (Optional) 340 from being energized while the islanding adaptor interface 300 is unmated. This reduces the possibility of electric shock or spark while removing or mating the adaptor interface 335.

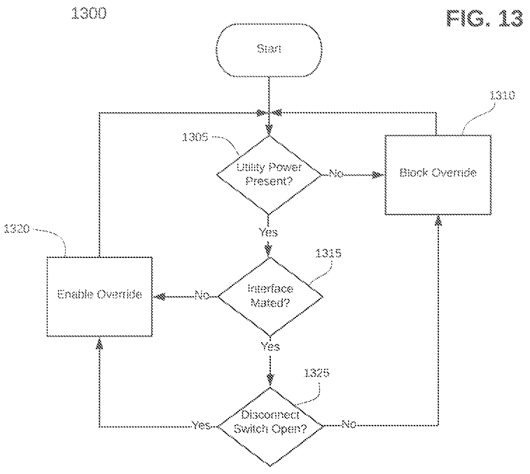

The logic starts 1100 when power is applied to the control circuit by either the Utility service 100 or the EV grid forming interface 740 source. Determining if the islanding relay 920 is manually overridden 1105 is the first decision. The ability to manually override the relay is controlled by the Automatic Reset Manual Override (ARMO) 1200 that operates in accordance with the logic depicted in FIG. 13. If the Islanding relay 920 is overridden, then the control system opens the grid forming relay 1140 contacts. If it is not overridden, then it continues to detect if a dummy adaptor interface is inserted 1110 into the IMSA 200.

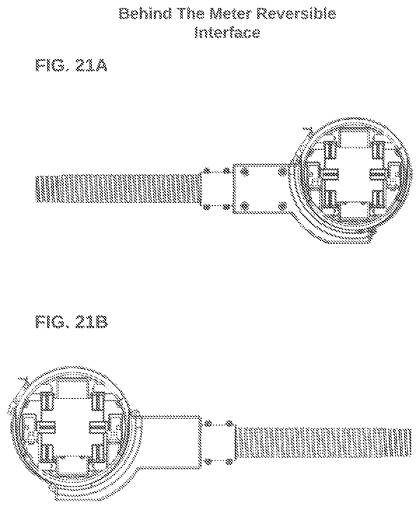

The dummy adaptor interface is used to safely cover the IMSA interface ports when an active adaptor interface 335 is not in service. If the dummy adaptor interface is inserted, then the islanding relay 920 is shut 1145 so utility power can flow to the standard main service panel 120. If the dummy interface is not in place, then the system detects if an active adaptor interface 335 is mated 1115 as shown in FIG. 20B.

If the adaptor interface is not mated, then the control system opens the islanding relay 920 contacts 1130 thus de-energizing the power interface 340. If the adaptor interface 335 is mated, then the system detects if power from the utility service 105 is present 1120. If the power from the utility service 105 is not present, then it waits for a utility down delay timed out 1125.

The utility down delay timed out 1125 is intended to prevent rapid cycling of the relay system and EV power source in the event of short power interruptions. An example of a short interruption occurs when utility power is lost due to an intermittent short circuit that is subsequently cleared after a breaker reclosing cycle. These interruptions typically are only several seconds in duration.

If the utility power is still down after the delay time out, the control system opens the islanding relay contacts 1150 and then shuts the grid forming relay contacts 1135 thus enabling the grid forming EV source to power 135 the main service panel 120.

If utility power is present, the control system opens the grid forming relay contacts 1155 and then waits for a short delay 1160 to allow the loads on the main panel to fully drop. Transferring load too quickly can cause large system transients induced in inductive or capacitive loads that could trip power sources or circuit breakers. Once the load drop delay has expired, the islanding relay contacts are shut 1165 and the service panel 120 is powered from the Utility service 100.

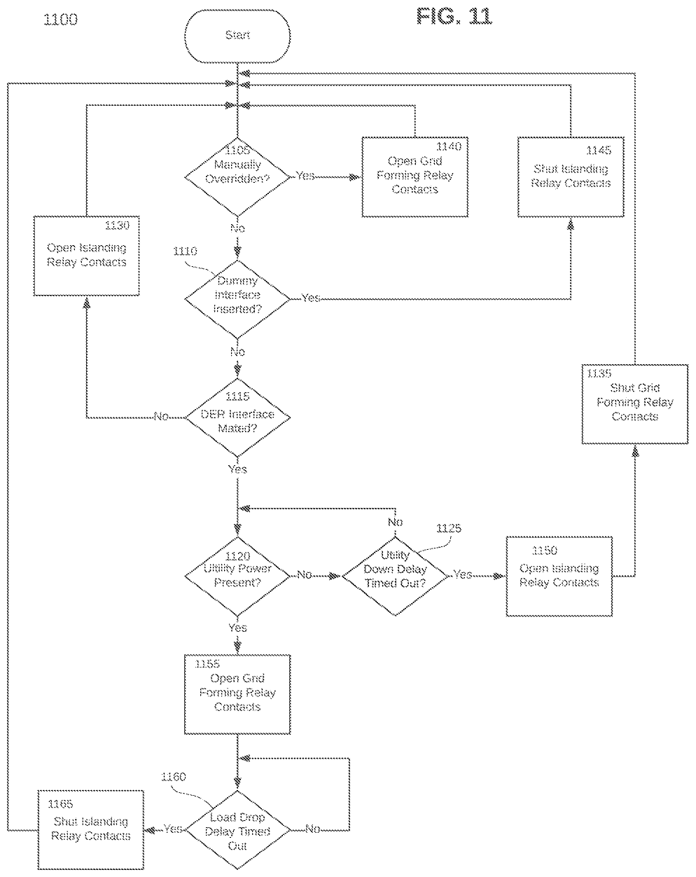

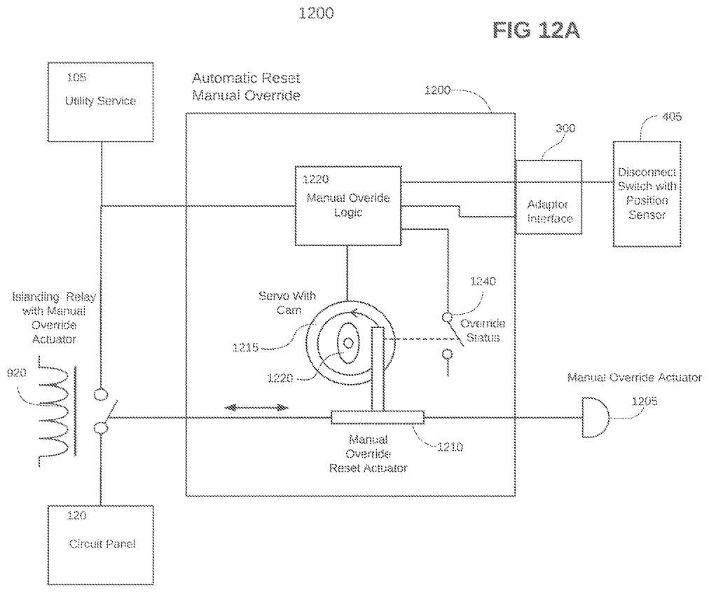

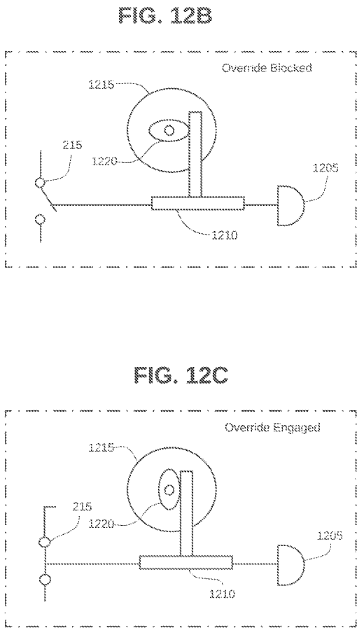

FIG. 12A Illustrates the automatic reset manual override (ARMO) 1200 component. This device allows for the manual operation of the Islanding relay 920 contacts under certain conditions. One possible condition is where the monitoring and control circuit 910 fails and the Islanding relay 920 is in the open position. If the utility power returns to service, the manual override actuator 1205 can be utilized to shut the islanding relay 920 contacts and restore power to the service panel 120.

The ARMO 1200 device is totally separate from the control circuit 210 so that failure in the control circuit is unlikely to affect the ARMO 1200 thus enabling power restoration if the utility power is present.

The ARMO 1200 will also automatically open and lockout the Islanding relay 920 contacts if utility power is lost. This prevents any power generation source that is connected to the load side of the islanding relay from feeding power back to the utility grid. This protects utility maintenance personnel from being exposed to energized components during a utility power outage.

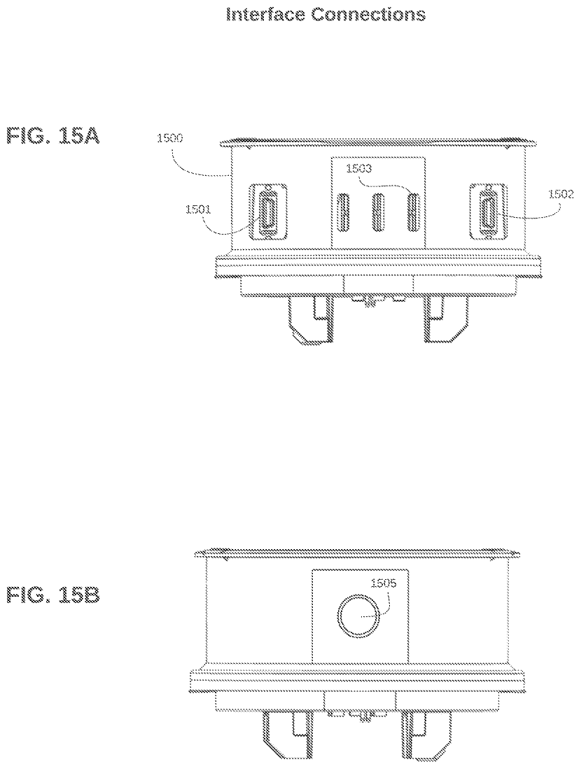

The ARMO can be reset and locked out by moving the manual override reset actuator 1210 with a cam device 1220 causing the ARMO to be disabled. The cam device 1220 is motivated by a servo or solenoid 1215 that is controlled by the manual override logic 1220 depicted in FIG. 15.

FIG. 12A shows the manual override reset actuator 1210 and servo with cam 1220 device in the position that enables shutting of the islanding relay 920 using the manual override actuator 1205.

FIG. 12B shows the manual override reset actuator 1210 and cam device 1220 in the position that locks out the ability to shut the islanding relay contacts 920 using the manual override actuator 1205.

FIG. 12C shows the manual override reset actuator 1210, the cam device 1220, and the islanding relay contacts 215 shut.

The override status switch 1240 indicates the position of the manual override actuator. This status can be used in the resilience logic depicted in FIG. 11.

FIG. 13 illustrates ARMO 1200 Logic. The system starts 1300 when power is applied to the logic. The first decision is to determine if utility power is present 1305.

If utility power is not present, the override opens the islanding relay contacts and blocks the override 1310 from being actuated. Opening the islanding contacts prevents any grid forming generator from feeding power to the grid while maintenance personnel could be exposed to energized components during a utility power outage.

If utility power is present, then it determines if an adaptor interface 335 is mated 1315 with the islanding meter socket adaptor 300.

If the interface is not mated, then the override is enabled 1320 allowing the islanding relay to be shut. When the interface is not mated there is no path for grid forming generator power to flow back to the utility therefore it is safe to override the islanding relay. If the interface is mated, then the system determines if the disconnect switch is open 1325.

If the disconnect switch is open, then the override is enabled 1320. When the disconnect is open there is no path for grid forming generator power to flow back to the utility therefore it is safe to override the islanding relay.

If the disconnect is shut, the override is blocked 1310 from being actuated. Blocking the override prevents any grid forming generator from feeding power to the grid while maintenance personnel could be exposed to energized components during a utility power outage.

FIG. 14A depicts one embodiment of the islanding meter socket adaptor.

FIG. 14B illustrates the enclosure 1400 and main power carrying components. The meter jaws 1408, 1407, 1409, 1410, 1405, the mate socket jaws 1411, 1412, 1413, and the islanding relay 1406.

FIG. 14C illustrates the control electronics enclosure 1423, electronics PCB 1422, and control interface connectors 1420, 1421.

FIG. 15A illustrates the control interfaces 1501, 1502, and the power interfaces 1503.

FIG. 15B illustrates the Automatic Reset Manual Override actuator 1505.

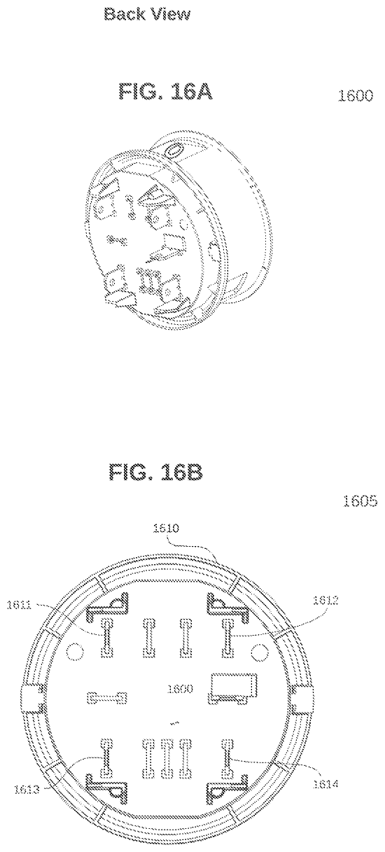

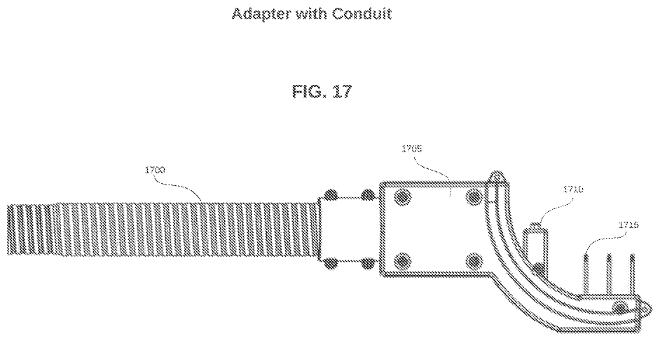

FIG. 16A depicts the back view of the meter socket adaptor this side mates with a standard meter socket.

FIG. 16B illustrates the meter socket adaptor enclosure 1610 back interface components including the meter socket stabs 1611, 1612, 1613, 1614.

FIG. 17 illustrates the adaptor Interface 335 with a conduit 1700 to route the power and control cables to the electric vehicle charger interface 150. The other components are the interface casing 1705, the control interface connector 1710, and the power interface stabs 1715.

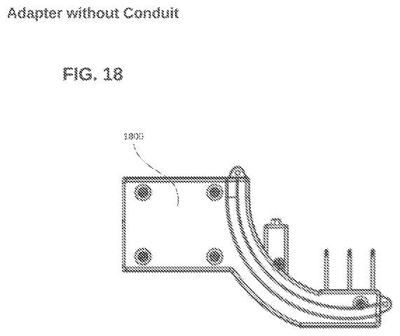

FIG. 18 depicts the Adaptor Interface 335 without power or control cabling routed to the electric vehicle charger interface 150. This embodiment shows the configuration utilizing wireless communications between the adaptor and charger. In some implementations, the interface casing 1800 includes an antenna for transmitting data to and from the adaptor interface 335.

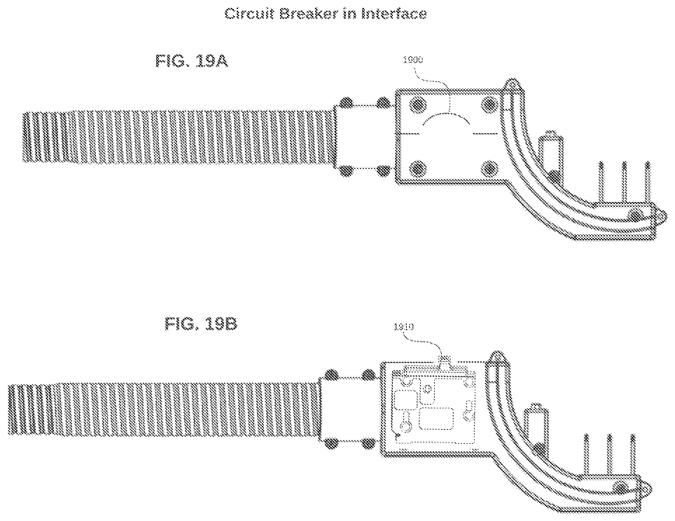

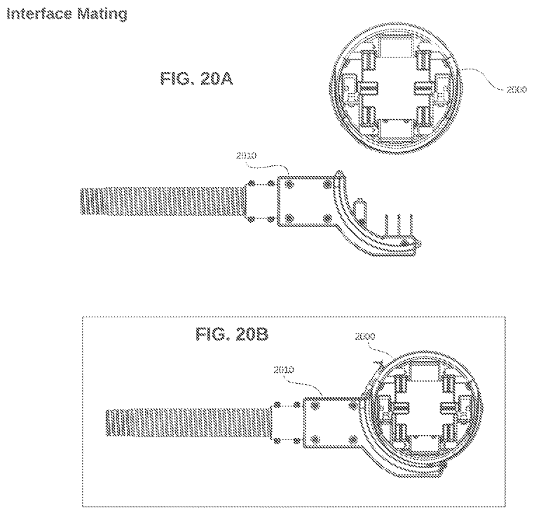

FIGS. 19A and 19B depict the adaptor with a disconnect and circuit protection devices in the adaptor 1900, 1910. This enables the system to be deployed without a separate fusible disconnect thus reducing the number of components needed to install at the site.

FIGS. 20A and 20B illustrate the mating of the interface adaptor 2010 and the meter socket adaptor 2000. FIG. 20A shows the adaptor unmated. FIG. 20B shows the adaptor mated.

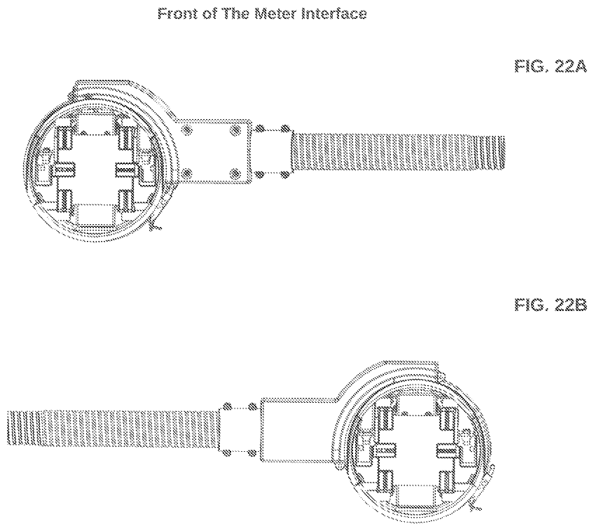

FIGS. 21A and 21B show the interface adaptor mated in two different directions. The interface adaptor is symmetrical so it can be mated such that the conduit exits in the right-hand or left-hand directions. This enables installation flexibility to ease the placement of the other system components and avoid potential interferences.

FIGS. 22A and 22B show the meter and interface adaptors rotated 180 degrees to enable a “front of the meter” (FTM) connection. This configuration is depicted in FIG. 10. This configuration can also mate in right-hand or left-hand configurations to facilitate installation.

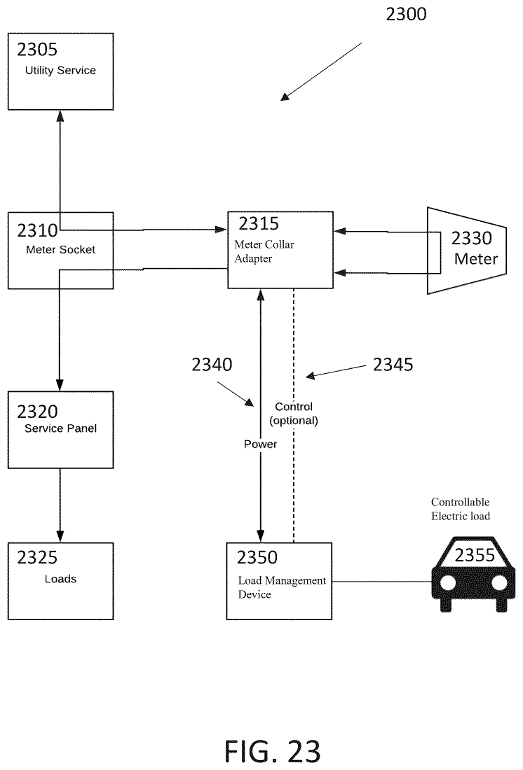

FIG. 23 shows a schematic drawing of a power distribution system, in accordance with at least one example embodiment described and recited herein. As depicted, system 2300 includes, at least, utility service 2305, meter socket 2310, meter collar adapter 2315, service panel 2320, loads 2325, electric meter 2330, load management device 2350, and electric equipment, such as, DER or controllable electrical load 2355, such as, an electric vehicle and its associated supply equipment, such as a charger.

Utility service 2305 may refer to a public utility distribution system that supplies two-phase power via a meter to a customer, such as a residential power system, e.g., utility grid.

Meter socket 2310 may refer to a socket having utility-side contacts to interface with utility service 2305 and customer-side contacts to electrically connect to a customer's private distribution system, e.g., meter collar adapter 2315 and service panel 2320.

Meter collar adapter 2315 may refer to a device that plugs into the meter socket 2310 and resides between the meter socket and electric meter 2330.

Service panel 2320 may refer to the main service panel that provides a distribution point for the customer's loads 2325. This panel usually contains circuit protection devices and terminal points that enable the distribution of power through the private facility.

Loads 2325 may refer to the typical loads found in a private facility. Some examples of typical loads include, but not limited to, electric appliances, air conditioners, electric hot water heaters, and electric outlets.

Electric meter 2330 may refer to a power metering device that plugs into the meter collar adapter 2315. Electric meters are typically utilized to monitor the power consumption or production at a Utility customer's facility for the purpose of billing for the utility service.

Load management device 2350 may refer to a charger interface that may interact with meter socket adapter 2315 to safely enable a co-located (on the same premises) electric equipment, e.g., electric vehicle 2355, to electrically connect to the load (or line) side of meter socket 2310. Load management device 2350 may be housed in the meter collar adapter 2315. In accordance with at least one example embodiment described and recited herein, load management device 2350 may reside onboard controllable electric load 2355, such as, the electric vehicle, to reduce the number of external enclosures needed for system 2300. Alternative form factors include separate enclosures that house EV car chargers or other multi source backup inverters. As used herein, electrically connect or connected refers to both mechanical connection, e.g., wired connection, and a connection that allows the flow of energy, e.g., electrical load.

In accordance with one example operational flow, as described and recited herein, power may be supplied to load management device 2350, via utility service 2305, meter socket 2310, meter collar adapter 2315, and wires 2340; and communications in the form of digital or analog signals to enable or disable the connection of the controllable electric equipment 2355, such as, the electric vehicle, may be supplied to load management device 2350 via wires 2345. In addition, load management device 2350 may communicate with the controllable electric equipment 2355, such as, the electric vehicle, to modify the parameters including, but not limited to, power output level or power factor compensation.

In accordance with at least one example implementation, power may be routed directly from the load side of meter collar adapter 2315 to load management device 2350. In accordance with at least one additional or alternative implementation, controllable electric equipment 2355, such as, the electric vehicle, may supply power to the grid or to loads 2325. The aforementioned implementations may be enacted depending on program settings, determined by the local utility regulations and end user inputs, programed into the monitoring and control circuit.

In accordance with a non-limiting example implementation, in the event of a grid outage, meter collar adapter 2315 may be configured to disconnect from the grid, i.e., utility service 2300, while maintaining an electrical connection to load management device 2350 as well as the controllable electric equipment 2355, such as, electric vehicle, and to service panel 2320, thereby supplying power from controllable electric equipment 2355, such as, the electric vehicle, to loads 2325. Meter collar adapter 2315 may be configured to inform the load management device 2350 that the islanding relay contacts are open by sending a signal over the control interface 2345. Accordingly, load management device 2350 may enable the electric vehicle to energize the power connection and pick up the service panel 2320 and loads 2325.

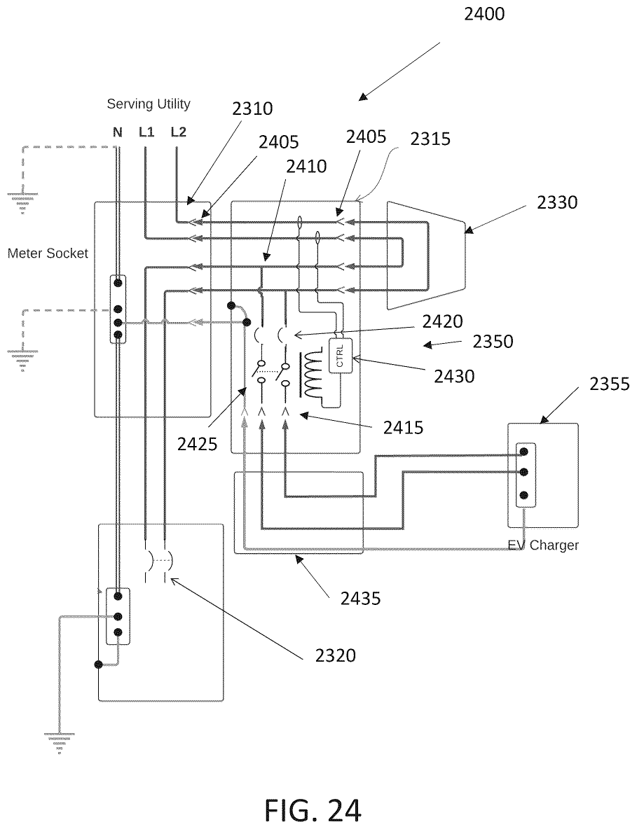

FIG. 24 shows a schematic drawing of a power distribution system 2400 including the load management device with overcurrent protection, in accordance with at least one example embodiment described and recited herein. That is, FIG. 24 shows system 2400 that includes meter collar adapter 2315 including the load management device 2350 interconnected at a site with electrical loads on a grid side circuit interconnection point, with power flowing between the grid, the site, and the controllable electrical load.

Meter collar adapter 2315 houses the mating contacts or connectors for the power and control interfaces which may be electrically connected to the meter collar adapter 2315, which may have plug type connectors for, e.g., AC power Line 1, Line 2, and Neutral, e.g., ground. In an embodiment, the meter collar adapter 2315 includes a plurality of contacts 2405 to electrically connect the meter collar adapter 2315 to a meter socket 2310, which is connected to the AC power lines L1, L2 and neutral, and to connect to utility meter 2330.

In accordance with at least one example implementation, the meter collar adapter 2315 houses the load management device 2350. In an another embodiment, the load management device 2350 is connectable to the meter collar adapter 2315 which facilitates the electrical connection of the load management device 2350 to the power lines.

As depicted, load management device 2350 includes, at least, interface circuit 2410, interface contact 2415, overcurrent protection device 2420, an adjustable electrical switch 2425, and an energy management unit 2430.

Optionally, the load management device 2350 further includes a communications module, for example, transceivers, for transmitting and receiving data. This communication may be used to transmit the total electrical load, position of the adjustable electrical switch, amount of electrical load for the co-located electric equipment, or the like to co-located electric equipment(s) or interested stakeholders, for example, customers, the owner of the residential building, utility operators, installers, investors, aggregators, or the like to help manage the electrical loads for the building or utility grid. The communications may be implemented in many forms including but not limited to digital IO, analog IO, and industrial standard serial protocols or wireless communications, e.g., Bluetooth, Wi-Fi, Internet, NEC, RF, or the like.

Interface circuit 2410 may be integrated into the meter collar adapter 2315 to electrically connect to at least one of a line side (utility side of meter) or load side (premises/customer side of meter) of a service line, e.g., L1 or L2, through the utility meter 2330 to a primary load 2325 through the service panel 2320 and the utility meter. Interface circuit 2410 may also be electrically connected to the external, co-located electric equipment 2355.

The external, co-located electric equipment 2355 may include a bidirectionally capable distributed energy resource (DER), such as an electric vehicle or energy storage batteries, and its associated supply equipment (EVSE), such as a charger, or power export equipment (EVPE).

In a non-limiting example, the interface circuit 2410 may include an interface contact 2415 to electrically connect the co-located electric equipment 2315 to the interface circuit 2410. In an embodiment, the interface contact 2415 may be provided to directly connect to the EVSE or DER, e.g., a pluggable outlet. In another embodiment, the interface contact 2415 may be a plug type connector that is electrically connected to a touch-safe field-removable and reversible junction box 2435.

Touch-safe field-removable and reversible junction box 2435 may be connected to the meter collar adapter 2315 via an externally accessible connector, e.g., on an outer surface of the meter collar adapter 2315. Touch-safe field-removable and reversible junction box 2435 may be electrically connected to the EVSE, such as a charging unit 2355 for charging the DER, or may include service equipment directly connected with the DER. It is appreciated that the touch-safe field-removable and reversible is a connectable system that may be a pluggable power interface. The junction box may include any of the following features: field-wireable, weatherproof and removable junction box, integrated power and ground connectors capable of quick-connect/quick-release mating, hinged clasps that secure junction box to meter socket adapter, and are capable of being locked in the secured position (as is typical with ‘lockout/tagout’ safety protocol), one or more contactors or overcurrent protection devices, one or more CT's for sensing power/current, and one or more communication modules to capture and transmit data such as measurements of electrical load through the MSA. The load measurements can include voltage, current, power, and other measurements of electrical load or electrical signals through the MSA. It is appreciated that the term reversible is at least directed to being mountable or pluggable in either the right or left mount positions in the meter collar adapter. As such, junction box 2435 is a touch-safe field-removable and reversible junction box in-line with the interface circuit to the electric equipment that facilitates the connection and disconnection of the interface circuit from the electric equipment without the need for tools.

Overcurrent protection device 2420 is electrically connected in series with the interface circuit 2410. Overcurrent protection device may include circuit breakers that are integrated into the interface circuit to provide overcurrent protection against short circuit faults. As such, overcurrent protection device 2420 provides circuit protection between the utility side connection to service lines L1, L2 and the external, co-located electric equipment 2355 as close as practical to the service entrance at the meter socket 2315. The overcurrent protection device can consist of, but is not limited to, circuit breakers or fuses rated for the power flow being provided by the backup source, e.g., between 30 A and 100 A, and preferably between 40 A and 60 A. In a non-limiting embodiment, overcurrent protection device 2420 may protrude from the housing of the meter socket adapter 2315 so that it may be accessible externally of the meter socket adapter 2315. As such, overcurrent protection device 2420 may be operated manually, e.g., tripping the circuit breaker manually, and/or allows the replacement of the breaker switch or fuse when necessary, e.g., replacing with higher amperage switch or fuse or blown switch or fuse.

Adjustable electrical switch 2425 is electrically connected in series with the interface circuit 2410. Adjustable electrical switch 2425 is configured to control an amount of electrical load through the interface circuit 2410 to the co-located electric equipment. In a non-limiting example, adjustable electrical switch 2425 may be an open/close relay switch that opens to disconnect the co-located electric equipment 2355 from the utility service lines L1, L2. In an another non-limiting example, the adjustable electrical switch 2425 may include an adjustable resistor, e.g., rheostat, to adjust the amount of electrical load through the interface circuit 2410 to the co-located electric equipment. It is appreciated that adjustable electrical switch 2425 may include alternative designs and controls, for example, controlling the flow of current by adjusting the timing of the opening and closing of the relay switch or having multiple resistors and switches in parallel to control the amount of the electrical load to the co-located electric equipment.

Energy management unit 2430 measures electrical load through the utility meter 2330 and controls a position of the adjustable electrical switch 2425 to manage the electrical loads to the co-located electric equipment 2355. In a non-limiting example, energy management unit 2430 includes a processor or micro-processor and/or memory to receive measurements of the electrical load, e.g., via current sensors on the utility service lines L1, L2 and/or the interface circuit to the co-located electric equipment and determines the amount of electrical load that may be provided to the co-located electric equipment 2355. In an embodiment, energy management unit 2430 is powered via the load side of the utility service line to simply the power supply design. In an another non-limiting example, energy management unit 2430 includes analog circuitry and discrete digital logic for managing the amount of electrical load to the co-located electric equipment.

Energy management unit 2430 monitors the electrical load provided through the utility service lines L1, L2 that provides power to the primary load 2325, e.g., residential house loads, and the co-located electric equipment 2355, e.g., EVSE or charger. Based on the measured electrical load, the energy management unit 2430 determines the total electrical load provided through the utility meter 2330 and compares the total electrical load to the service rating of the residential (or commercial) building, e.g., rating of whole service (100 AMP, 200 Amp, or 320 Amp). It is appreciated that the service rating of the residential or commercial building may be determined based on a number of different components, for example, in a non-limiting example, the main service wire(s), meter socket rating, panel ratings, utility capabilities, or the like.

If energy management unit 2430 determines that the total electrical load is greater than or within a predetermined threshold of the service rating of the residential (or commercial) building, energy management unit 2430 controls the position of the adjustable electrical switch 2425 to perform at least one of disconnecting the co-located electric equipment 2355, adjusting an amount of electrical load provided to the co-located electric equipment 2355, or a combination thereof. In an embodiment, the predetermined threshold may be +/−5% of the maximum service rating of the residential building. In a non-limiting example, the energy management unit 2430 may control the adjustable electrical switch 2425 to disconnect if the total electrical load is greater than the predetermined threshold for longer than 0.1 seconds.

In a non-limiting embodiment, energy management unit 2430 may control the adjustable electrical switch 2425, which may be an open/close relay switch, to an open position which disconnects or stops the flow of the electrical load to the co-located electric equipment 2355. As such, the total aggregate electrical load through the service lines will decrease and be below the service rating of the residential (or commercial) building.

Energy management unit 2430 may then determine when the co-located electric equipment 2355 may be reconnected to the utility service lines for receiving the electrical load. For example, in a non-limiting embodiment, when the electrical load to the primary load(s) of the residential building falls below a predetermined threshold value, e.g., below 120 A for a service rating of 200 A, control logic of the energy management unit 2430 determines whether or not the co-located electric equipment 2355 may be reconnected so that the total electrical load remains below the service rating of the residential building. In an embodiment, if the electrical load to the primary load(s) is below 120 A for five minutes, the energy management unit 2430 may control the adjustable electrical switch to close so that electrical load can be supplied to the co-located electric equipment.

It is appreciated that since the electrical load should not be provided at or near the maximum amount of continuous electrical load for prolonged periods of time allowed by the electrical system, e.g., due to excessive heat generation, the determination of whether or not the co-located electric equipment 2355 should be reconnected may be based on various additional conditions or factors.

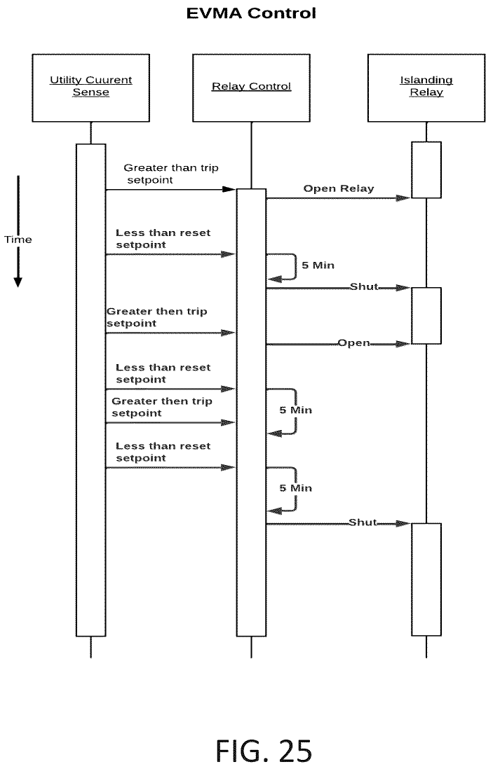

FIG. 25 illustrates an example embodiment for controlling the reconnection of the co-located electric equipment. As seen in FIG. 25, if the total electrical load is greater than the predetermined threshold, the energy management unit 2430 controls the adjustable electrical switch 2425 to open to disconnect the co-located electric equipment 2355 from the utility service line(s). After energy management unit 2430 determines that the total electrical load is below a predetermined reset threshold, for example, below 60 to 50% of the maximum service rating, e.g., 120 A or 100 A for a 200 A system, for a predetermined amount of time, e.g., one, five, ten, or fifteen minutes, the energy management unit 2430 controls the adjustable electrical switch 2425 to close to reconnect the co-located electric equipment 2355. Energy management unit 2430 may also include logic to determine, whether after the closing of the adjustable electrical switch 2425, the reconnection of the co-located electric equipment 2355 will increase the total electrical load to be greater than the predetermined threshold. If the total electrical load would be greater than the predetermined threshold, energy management unit 2430 maintains the adjustable electrical switch 2425 in the open position. If after the predetermined amount of time the total electrical load is determined to be below the predetermined reset threshold, energy management unit 2430 may close the adjustable electrical switch 2425 to reconnect the co-located electric equipment 2355.

In an embodiment, if the logic determines that the total electrical load is above the predetermined threshold, energy management unit 2430 may increase the amount of time the co-located electric equipment 2355 should be disconnected from the utility service line. For example, if the total electrical load is predicted to remain higher than 180 A, energy management unit 2430 may continue disconnection for ten minutes. If after ten minutes, energy management unit 2430 determines that the total electrical load would still be higher than the predetermined value, the energy management unit 2430 may then continue disconnection for thirty minutes.

In another non-limiting embodiment, energy management unit 2430 may reconnect the adjustable electrical switch 2425 if the total electrical load is below the predetermined threshold, e.g., 25 A below the utility service rating. If after the first attempt to reconnect fails, e.g., the total electrical load to the residential building and EVSE remains higher the predetermined threshold, the energy management unit 2430 may include a time delay, e.g., 30 minutes, for remaining below the predetermined threshold before attempting to reconnect the co-located electric equipment 2355. If the adjustable electrical switch 2425 is connected and even after the time delay attempt to reconnect, the energy management unit 2430 disconnects the adjustable electrical switch 2425, the load management device may enter into a lockout state which requires manual reset, e.g., a reset button, to reconnect the co-located electric equipment 2355.

In another non-limiting embodiment, energy management unit 2430 may control the adjustable electrical switch 2425 to adjust the electrical load to the co-located electric equipment 2355. For example, in an embodiment, the adjustable electrical switch 2425 may be an adjustable rheostat switch that changes the length of the resistor to control varying amounts of electrical load. As such, if additional electrical load is provided for the primary load(s), the total aggregate electrical load may be adjusted by decreasing the electrical load to the co-located electric equipment 2355 to maintain the total electrical load to be below the service rating of the residential (or commercial) building. It is appreciated that the adjusting of the electrical load to the co-located electric equipment 2355 may occur simultaneously with the instantaneous current readings of the electrical load measurements, e.g., PI or PID controller to maintain a set point of the total electrical load, or after the predetermined threshold is exceeded or a combination thereof. This embodiment may be used with the open/close relay switch, as discussed above, so that if, even after, reducing the electrical load to the co-located electric equipment 2355, the total electrical load is at or near the maximum service rating, the co-located electric equipment 2355 may be disconnected to decrease the total electrical load.

In a non-limiting embodiment, the energy management unit 2430 may include a field-configurable interface, such as, a selectable switch or button, to select different maximum service ratings for the meter collar adapter 2315. As such, the switch allows the selection of the operation of the energy management device to control the adjustable electrical switch 2425 by controlling when the adjustable electrical switch 2425 is opened or closed to disconnect the co-located electric equipment 2355 or the adjustment of the positions of the adjustable electrical switch to control the amount of electrical load supplied to the co-located electric equipment 2355. That is, the field-configurable interface is a device to adjust a load current rating of the load management device 2350 to set open and close conditions for the adjustable electrical switch 2425 for disconnecting the co-located electric equipment 2355. For example, the selection switch may include selection of a 100 A, 200 A, or 320 A service (or in 25 A increments between 100 A and 200 A). If the 100 A service is selected, the energy management unit 2430 is programmed such that the energy management unit 2430 controls the adjustable electrical switch to disconnect or control the amount of electrical load when a predetermined threshold of 95 A is reached or exceeded and reset when the predetermined reset threshold of 60 A is reached. Similarly, if the 200 A service is selected, energy management unit 2430 controls the adjustable electrical switch to disconnect or control the amount of electrical load when a predetermined threshold of 190 A is reached or exceeded and reset when the predetermined reset threshold of 120 A is reached.

Energy management unit 2430 may also include an interlock that is hardwired or provided by software that prevents the closing of the adjustable electrical switch 2425. For example, in an embodiment, the interlock may be set at 25 A below the maximum service rating, which prevents the reclosing (or auto-reclosing) of the adjustable electrical switch 2425 unless the total electrical load is below the interlock value.

Energy management unit 2430 may also include a visual indicator to indicate a status of the load management device 2350. For example, in an embodiment, the visual indicator may be a color-coded LED, e.g., red and green, to show whether the adjustable electrical switch is in the open position, e.g., disconnecting the co-located electric equipment, or the closed position, e.g., connect the co-located electric equipment. In an embodiment, the visual indicator may be a single LED or an indication on a display, e.g., percentage of electrical load or open or closed, that may be viewed externally.

As such, the load management device 2350 and energy management unit 2430 provides for a method which includes collecting current data from one or more current sensors on at least a line side or a load side a utility meter, e.g., service line; analyzing the current data to determine management of an electrical load to an external, co-located electric equipment by controlling an adjustable electrical switch of a load management device; and managing the electrical load to the external, co-located electric equipment by controlling a position of the adjustable electrical switch.

In a non-limiting embodiment, the managing of the electrical load includes at least one of setting an electrical current predetermined threshold for a total electrical load through the service line; controlling the adjustable electrical switch when a measured current supplied through the service line to both the primary load and the interface circuit exceeds the predetermined threshold; controlling the adjustable electrical switch when the measured current to both the primary load and interface circuit is below the predetermined threshold; opening the adjustable electrical switch when the measured current supplied through the service line to both the primary load and the interface circuit exceeds the predetermined threshold; and reclosing the adjustable electrical switch, after a time-delay, when the measured current supplied through the service line to both the primary load and interface circuit falls below a predetermined reset threshold, for a period of time.

In yet another non-limiting example, the meter collar adapter 2315 having the load management device 2350 includes the adjustable electrical switch 2425 that includes at least one of the following: in a default closed state, such that when installing the meter collar adapter 2315 on the meter socket 2310, the manual or automated opening of the adjustable electrical switch 2425 opens the interface circuit 2410 and resets control protocols for controlling the electrical load to the co-located electric equipment 2355, or in a default open state, such that the adjustable electrical switch is in the closed state after a selection of a control for a service rating for the load management device.

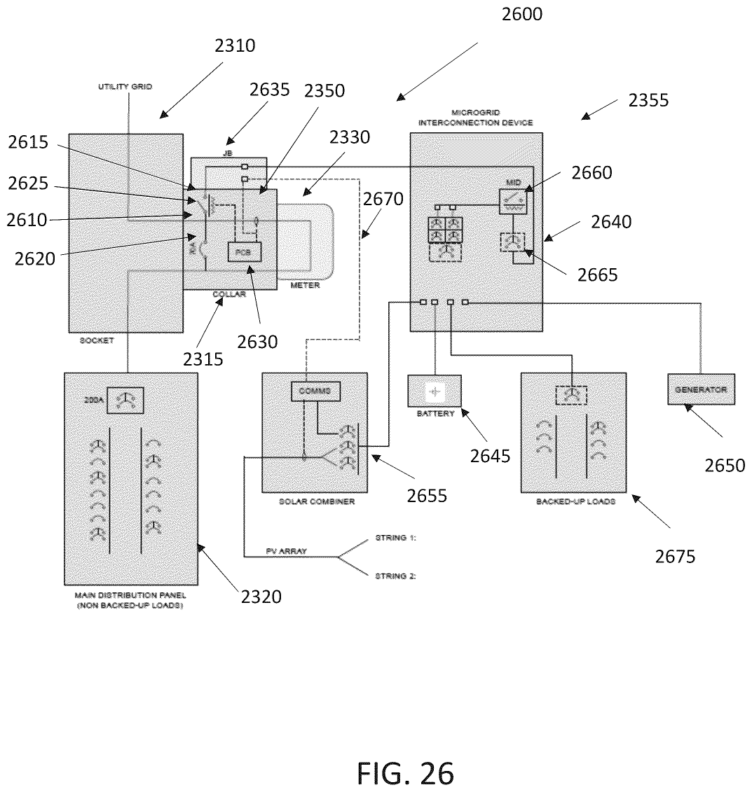

FIG. 26 shows a schematic drawing of a power distribution system 2600 having the load management device with overcurrent protection, in accordance with at least one example embodiment described and recited herein. That is, FIG. 26 shows system 2600 that includes meter collar adapter 2315 including the load management device 2350 interconnected at a site with electrical loads, with power flowing between the grid, the site, and the controllable electrical load.

Meter collar adapter 2315 houses the mating contacts or connectors for the power and control interfaces which may be electrically connected to the meter collar adapter 2315, which may have plug type connectors for, e.g., AC power Line 1, Line 2, and Neutral, e.g., ground. In an embodiment, the meter collar adapter 2315 includes a plurality of contacts to electrically connect the meter collar adapter 2315 to a meter socket 2310, which is connected to the AC power lines and neutral, and to connect to utility meter 2330.

In accordance with at least one example implementation, the meter collar adapter 2315 houses the load management device 2350. In another embodiment, the load management device 2350 is connectable to the meter collar adapter 2315 which facilitates the electrical connection of the load management device 2350 to the power line(s).

As depicted, load management device 2350 includes, at least, interface circuit 2610, interface contact 2615, overcurrent protection device 2620, an adjustable electrical switch 2625, and an energy management unit 2630.

Interface circuit 2610 may be integrated into the meter collar adapter 2315 to electrically connect to at least one of a line side or load side of a service line through the utility meter 2330 to a primary load 2325 through the service panel 2320. Interface circuit 2610 may also be electrically connected to the external, co-located electric equipment 2355.

In a non-limiting example, the interface circuit 2610 may include an interface contact 2615 to electrically connect the co-located electric equipment 2355 to the interface circuit 2610. In an embodiment, the interface contact 2615 may be provided to directly connect to the co-located electric equipment, e.g., EVSE, DER, ESS, etc. In another embodiment, the interface contact 2615 may be a plug type connector that is electrically connected to a touch-safe field-removable and reversible junction box 2635.

Touch-safe field-removable and reversible junction box 2635 may be connected to the meter collar adapter 2315 via an externally accessible connector, e.g., on an outer surface of the meter collar adapter 2315, without the use of tools. Touch-safe field-removable and reversible junction box 2635 may be electrically connected to the co-located electric equipment 2355, such as, EVSE, directly or through co-located electrical equipment, e.g., a microgrid interconnection device 2640 to allow a bidirectional flow of electrical energy and/or data from bidirectionally capable distributed energy resource(s) (DER), such as an electric vehicle or energy storage batteries 2645, or power export equipment (EVPE). As such, the microgrid interconnection device 2640 is provided to help facilitate a bidirectional connection with the DERs and integrated automatic switching of interface circuit, from utility-connected to islanded (disconnected from utility grid), and back to utility connected, based on the availability status of the local utility grid at any time. Microgrid interconnection device 2640 may reside in a separate enclosure that provides the interconnection between meter socket adapter 2315 and the DERs. Microgrid interconnection device 2640 houses the components needed to isolate the DER outputs from interconnection to the grid at meter collar adapter 2315, and transfer the power connection to the islanded grid forming interface and backed-up loads 2675 in the event of a utility power outage.

As depicted in FIG. 26, microgrid interconnection device 2640 may include disconnect switch 2660 and terminal connections and/or overcurrent protection 2665 for the DERs and backed-up loads 2675.

Based on data through data line 2670, which may be hardwired or transmitted wirelessly, and/or voltage sensing of the interface circuit 2610 regarding grid power status received via meter collar adapter 2315, microgrid interconnection device 2640 may operate disconnect switch 2660; alternatively, based on the data regarding grid power status received via meter collar adapter 2315, microgrid interconnection device 2640 may operate disconnect switch 2660 to switch to islanding mode to/for devices capable of operating in islanding mode to supply electrical load to the backed-up loads 2675, which may be the same or different loads associated with the primary load 2325 of the residential building. Microgrid interconnection device 2645 may also allow using the DERs, e.g., the solar combiner and/or battery to act as an electrical source to supply electrical energy to the primary loads and/or the utility grid when disconnect switch 2660 is closed and the utility grid is present.

Overcurrent protection device 2620 is electrically connected in series with the interface circuit 2610. Overcurrent protection device may include circuit breakers that are integrated into the interface circuit to provide overcurrent protection again short circuit faults. As such, overcurrent protection device 2620 provides circuit protection between the utility side connection to service lines and the external, co-located electric equipment 2355 as close as practical to the service entrance at the meter socket 2315.

Adjustable electrical switch 2625 is electrically connected in series with the interface circuit 2610. Adjustable electrical switch 2625 is configured to control an amount of electrical load through the interface circuit 2610. In a non-limiting example, adjustable electrical switch 2625 may be an open/close relay switch that opens to disconnect the co-located electric equipment 2355 from the utility service line. In an another non-limiting example, the adjustable electrical switch 2625 may include an adjustable resistor, e.g., rheostat, to adjust the amount of electrical load through the interface circuit 2410 to the co-located electric equipment.

Energy management unit 2630 measures electrical load through the utility meter 2330 and controls a position of the adjustable electrical switch 2625 to manage the electrical loads to the co-located electric equipment 2355. In a non-limiting example, energy management unit 2630 includes a processor or micro-processor to receive measurements of the electrical load, e.g., via current sensors on the utility service line and/or the interface circuit and determines the amount of electrical load that may be provided to the co-located electric equipment 2355.

Energy management unit 2630 monitors the electrical load provided through the utility service line that provides power to the primary load 2325, e.g., residential house loads, and the co-located electric equipment 2355, e.g., EVSE or charger. Based on the measured electrical load, the energy management unit 2630 determines the total electrical load provided through the utility meter 2330 and compares the total electrical load to the service rating of the residential (or commercial) building, e.g., rating of whole service (100 AMP, 200 Amp, or 320 Amp). It is appreciated that the service rating of the residential or commercial building may be determined based on a number of different components, for example, in a non-limiting example, the main service wire(s), meter socket rating, panel ratings, utility capabilities, or the like.

If energy management unit 2630 determines that the total electrical load is greater than or within a predetermined threshold of the service rating of the residential (or commercial) building, energy management unit 2630 controls the position of the adjustable electrical switch 2625 to perform at least one of disconnecting the co-located electric equipment 2355, adjusting an amount of electrical load provided to the co-located electric equipment 2355, or a combination thereof. In an embodiment, the predetermined threshold may be +/−5% of the maximum service rating of the residential building. In a non-limiting example, the energy management unit 2630 may control the adjustable electrical switch 2625 to disconnect if the total electrical load is greater than the predetermined threshold for longer than 0.1 seconds.

In a non-limiting embodiment, the energy management unit 2630 and the microgrid interconnection device 2640 may be controlled to manage bidirectional flow of electrical energy or electrical load to the utility grid. For example, the energy management unit 2630 may control the load management device 2350 to manage electrical load from the meter collar adapter 2315 to the external, co-located electric equipment or allow the external, co-located electric equipment 2355 to act as an energy source to supply the electrical energy back through the load management device 2350 and to the utility grid and/or act as a power source for the premises electrical system, e.g., for the primary loads. As such, since the load management device 2350 and the microgrid interconnection device 2640 may allow the connection and disconnection of the co-located electric equipment 2355 from the utility grid, primary loads, and/or the backed-up loads, the system components may communicate with each other to facilitate the direction, timing and quantity of electrical load or electrical energy through the load management device 2350. It is appreciated that the system components may include devices connected to the primary loads or backed-up loads, or electric equipment, and to third party devices, e.g., not associated with the meter collar adapter, meter socket, or utility meter, that are associated with the electric equipment, e.g., solar combiner from a third party vendor.

The meter collar adapter having the load management device, as discussed herein, has at least the following advantages:

Since the meter collar adapter and load management device are connected upstream or north of the service panel and/or the primary loads, e.g., the residential building, the connection to a co-located electric equipment is not limited by the service rating of the electrical panel of the residential building. Rather, the addition of any co-located electric equipment is limited by the service rating of the utility supply line, e.g., through the meter socket.

Furthermore, since the meter collar adapter is installed upstream of the service panel, the service panel does not have to be upgraded to accommodate for the connection to the co-located electric equipment.

Moreover, since the meter collar adapter is connected to the meter socket, the installer or technician is provided with a simpler interface for connection to a co-located electric equipment.

Additionally, since the energy management unit is receiving current data from the line side of the utility service line, a more accurate electrical load may be determined, e.g., sensing current downstream of the service panel could potentially have noise.

Since the meter collar adapter may include the load management device, additional overcurrent protection devices are not required by the service panel, but rather, the co-located electric equipment is protected from overcurrent by the load management device.

As discussed above, a pluggable junction box, or adaptor interface, can electrically connect a meter socket adapter (MSA) and an electrical circuit (e.g., one or more DERs). The pluggable junction box, or adaptor interface may also be referred to as a pluggable assembly. The pluggable assembly can be removably (i.e., pluggably) coupled to the meter socket adapter and enclose components such as metal stabs or electrical prongs to plug into the meter socket adapter. As shown in FIGS. 17-22, the pluggable assembly includes a housing, such as the interface casing 1705 of FIG. 17. A set of power interface connectors, such as the power interface stabs 1715 of FIG. 17 may extend from the housing to electrically connect to the MSA. The set of power interface connectors may be configured to be pluggably and removably coupled to the MSA. The set power interface connectors may be partially enclosed within the housing and may be connected to internal components in the housing of the pluggable assembly. In an example, the set of power interface connectors are connected to wire terminals in the housing of the pluggable assembly. The set of power interface connectors may be connected to an electrical circuit interface to electrically connect the set power interface connectors to the electrical circuit. The electrical circuit interface may include wires connecting the pluggable assembly to the electrical circuit, such as the conduit 1700 of FIG. 17 which connects an example pluggable assembly to an electric vehicle charger interface 150. In an example, the electrical circuit interface includes the wire terminals which are configured to be electrically connected to the power interface connectors when the pluggable assembly is plugged into the MSA. In an example, the electrical circuit interface includes an electrical whip coupled to the wire terminals which connects to wiring or cables (e.g., the conduit 1700) which lead to a DER. In an example, the electrical circuit interface includes a conduit, such as the conduit 1700 of FIG. 17. In some implementations, the electrical whip may be factory wired to the terminals. In some implementations, the terminals can be field-wired (e.g., wired during installation) to the electrical whip or cables.

The pluggable assembly may include a control interface connector extending from the housing to electrically connect to the MSA. The control interface connector, such as the control interface connector 1710, may be configured to be pluggably and removably inserted into the MSA. With the control interface connector and the set of power interface connectors configured to be pluggably and removably inserted into the MSA, the pluggable assembly may be pluggably and removably coupled to the MSA. The control interface connector may be configured to transmit data between the MSA and the electrical circuit. In an example, the control interface connector is coupled to a control circuit of the MSA and passes data between the control circuit of the MSA and a DER. The control interface connector can be generally referred to as a data interface connector. A data interface connector may provide the same functionality as a control interface connector, as well as additional functionality. The data interface connector may provide for transmitting data between the MSA and the DER, where some of the data includes control commands. The data interface connector may provide for transmitting load measurements from the MSA to a communications circuit (otherwise referred to as a data circuit) for a DER. In an example, the communications circuit or data circuit includes or is part of an EMS, or a PCS, as discussed herein. In an example, the data interface connector provides load measurements from the MSA to a DER for the DER to determine how to update its operating parameters. In an example, the DER provides a control signal to the MSA. In this example, the control signal is to actuate a switch in the MSA to disconnect the MSA from the utility grid and/or to disconnect the DER from the meter socket. The load measurements may be load through the DER. The load measurements include at least one of voltage, current, and power. The data interface connector may be symmetrical to allow the pluggable assembly to be pluggably coupled to the MSA in different orientations, as illustrated in FIGS. 21A-22B.

In some implementations, the housing of the pluggable assembly has a depth which is less than or equal to a depth of the MSA. The depth of the housing and the MSA may be measured along a direction of attachment of the MSA to a meter socket. The depth of the housing being less than or equal to the depth of the MSA may allow the pluggable assembly to be pluggably coupled to the MSA without removing the MSA from the meter socket or removing the meter from the MSA. In this way, the pluggable assembly can be pluggably and removably coupled to the MSA without tools (e.g., field-removable without tools).

In some implementations, the set of power interface connectors are symmetrical. The set of power interface connectors may be symmetrical along a first plane along the direction of connection of the MSA to the meter socket and/or symmetrical along a second plane perpendicular to the first plane. In an example, the set of power interface connectors are symmetrical along the first and second planes, as illustrated in FIG. 17. In some implementations, the set of power interface connectors may allow for the pluggable assembly to be removably coupled to the MSA in different orientations. In an example, the set of power interface connectors allow the pluggable assembly to be removably coupled to the MSA in a first direction perpendicular to the direction of connection of the MSA to the meter socket and in a second direction opposite the first direction. In an example, the set of power interface connectors allow the pluggable assembly to be removably coupled to the MSA such that cabling between the pluggable assembly and the electrical circuit extends to either the right or the left of the MSA, as illustrated in FIGS. 21A-22B. In some implementations, the set of pluggable power interface connectors are symmetrical to allow for coupling the pluggable assembly to the MSA in different orientations.

In some implementations, the pluggable assembly includes a circuit breaker within the housing of the pluggable assembly, as illustrated in FIG. 19A. The circuit breaker may be configured to disconnect the power interface connectors and the MSA in the event of removal of the pluggable assembly. In this way, the pluggable assembly may provide additional safety in the event the pluggable is disconnected from the MSA under power. The circuit breaker may also function to protect the electrical circuit and/or the MSA from overload. The circuit breaker may remove electrical load from the utility grid to the pluggable assembly and any connected DERs.

In some implementations, the housing of the pluggable assembly includes one or more of a hasp, clip, or latch for securing the pluggable assembly to the MSA. In an example, the housing includes hinged clasps to secure the pluggable assembly to the MSA. The hasp, clip, or latch may be configured to be locked in a secured position. In an example, the hasp, clip, or latch may be configured to receive a lock or fused wire to lock the pluggable assembly in the secured position. In this way, the pluggable assembly may provide for a lockout/tagout safety protocol, as discussed herein.

In some implementations, the pluggable assembly includes a current transformer within the housing of the pluggable transformer to measure electrical load through the pluggable assembly. The current transformer (CT) may sense one or more of power and current. The current transformer may measure electrical load between the electrical circuit and the MSA. The current transformer may measure electrical load at the wire terminations of the pluggable assembly. In some implementations, the pluggable assembly includes a communications module to communicate the measured electrical load to the MSA and/or the electrical circuit.

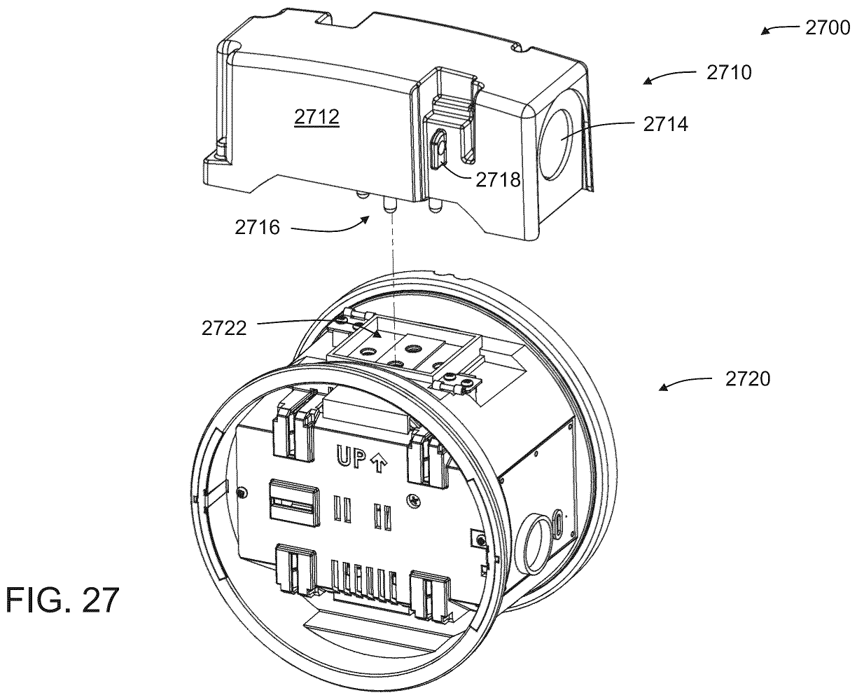

FIG. 27 illustrates an upper perspective view of a system 2700 including a pluggable assembly 2710 and a meter socket adapter (MSA) 2720. The pluggable assembly 2710 may be configured to be mated with the MSA 2720. The pluggable assembly 2710 may be similar to the adaptor interface of FIG. 17, the reversible junction box 2435 of FIG. 24, and/or the reversible junction box 2635 of FIG. 26. The pluggable assembly 2710 includes a housing 2712, an electronic circuit interface 2714, a set of power interface connectors 2716, and a hasp eye 2718. The pluggable assembly 2710 may electrically connect an electrical circuit, such as a DER, or a circuit connected to a DER, to the MSA. The pluggable assembly 2710 may be pluggably and removably coupled to the MSA 2720. When the pluggable assembly 2710 is mated with the MSA 2720, the pluggable assembly 2710 may complete an electrical and/or data connection between the electrical circuit and the MSA.

The housing 2712 may be electrically insulated such that the pluggable assembly 2710 is touch-safe. The housing 2712 may include weep holes such that water flows away from the MSA.

The electronic circuit interface 2714 may include an opening in the housing 2712 through which wires or cables pass to electrically connect the pluggable assembly 2710 with an electrical circuit. In some implementations, the electrical circuit includes or is connected to a DER. The electronic circuit interface 2714 may include electrical connections to the set of power interface connectors 2716, such as wire terminations of the set of power interface connectors 2716 within the housing 2712. In an example, a conduit extends through the electronic circuit interface 2714, the conduit including wires or cables to electrically connect the pluggable assembly 2710 with the electrical circuit. In some implementations, the conduit includes a data connection wire. In some implementations, a data connection wire is separate from the conduit, such as the wires 145 of FIG. 1, or the wired control connection 500 of FIG. 5.

The set of power interface connectors 2716 may extend from the housing 2712. The set of power interface connectors 2716 may include metal prongs which may or may not be connected to power. In some implementations, the pluggable assembly 2710 provides a data connection between the MSA 2720 and external electrical equipment (i.e., the pluggable assembly 2710 transmits data to and/or receives data from the external electrical equipment), and the set of power interface connectors 2716 carry no power but provide mechanical coupling between the pluggable assembly 2710 and the MSA 2720. In some implementations, the pluggable assembly 2710 provides a data connection and a power connection between the MSA 2720 and external electrical equipment. In some implementations, the pluggable assembly 2710 provides only a power connection between the MSA 2720 and external electrical equipment.

The set of power interface connectors 2716 may be configured to be inserted into a set of receptacles 2722 of the MSA 2720. The set of power interface connectors 2716 may be configured to electrically connect to electrical components of the MSA 2720. In an example, the set of power interface connectors 2716 electrically connect to line-side or service-side terminals of the MSA. The set of receptacles 2722 may be recessed into the housing of the MSA 2720 to restrict access to the set of power interface connectors 2716 when the pluggable assembly 2710 and the MSA 2720 are mated. In this way, the system 2700 allows for pluggable and removable coupling of the pluggable assembly 2710 and the MSA 2720 while preventing electrical shock when mating or separating the pluggable assembly 2710 and the MSA 2720.

In some implementations, the set of power interface connectors 2716 may be symmetrical. In some implementations, the set of power interface connectors 2716 may allow the pluggable assembly 2710 to be coupled to the MSA 2720 in different orientations. In an example, the illustrated arrangement of the set of power interface connectors 2716 allows the pluggable assembly 2710 to be coupled to the MSA 2720 in the orientation illustrated, or in an orientation where the pluggable assembly 2710 is facing the opposite direction.

The hasp eye 2718 may be configured to be coupled to a hasp hinge 2719 (not shown in FIG. 27) of the MSA 2719 to form a hasp to secure the pluggable assembly 2710 to the MSA 2720. In an example, a lock may be inserted in the hasp eye 2718 to prevent movement of the hasp hinge 2719 to secure the pluggable assembly 2710 to the MSA 2720. In this way, the pluggable assembly 2710 may be secured to the MSA 2720 and removed from the MSA 2720 by removing the lock and moving the hasp hinge 2719, which can be performed without tools.

The connection of the set of power interface connectors 2716 and the set of receptacles 2722 may be load-break rated such that the pluggable assembly 2710 may be removed under load. In some implementations, the pluggable assembly 2710 includes a circuit breaker. In an example, the pluggable assembly 2710 may be safely removed from the MSA 2720 by opening the circuit breaker and removing the pluggable assembly 2710. In some implementations, beginning to remove the pluggable assembly 2710 from the MSA 2720 signals to the MSA 2720 and/or the electrical circuit that the pluggable assembly 2710 is being removed, causing the MSA 2720 and/or the electrical circuit to cut power to the pluggable assembly 2710. In an example, a data connection between the pluggable assembly 2710 and the MSA 2720 and/or between the electrical circuit and the MSA 2720 is broken when beginning to remove the pluggable assembly 2710, causing the electrical circuit and/or the MSA 2720 to cut power to the pluggable assembly 2710.

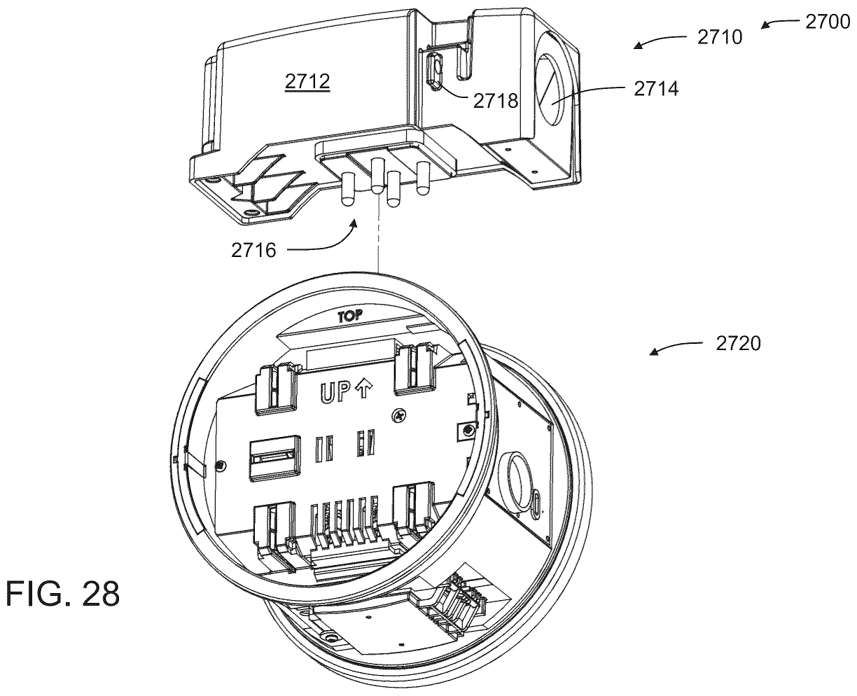

FIG. 28 illustrates a lower perspective view of the system 2700 of FIG. 27.

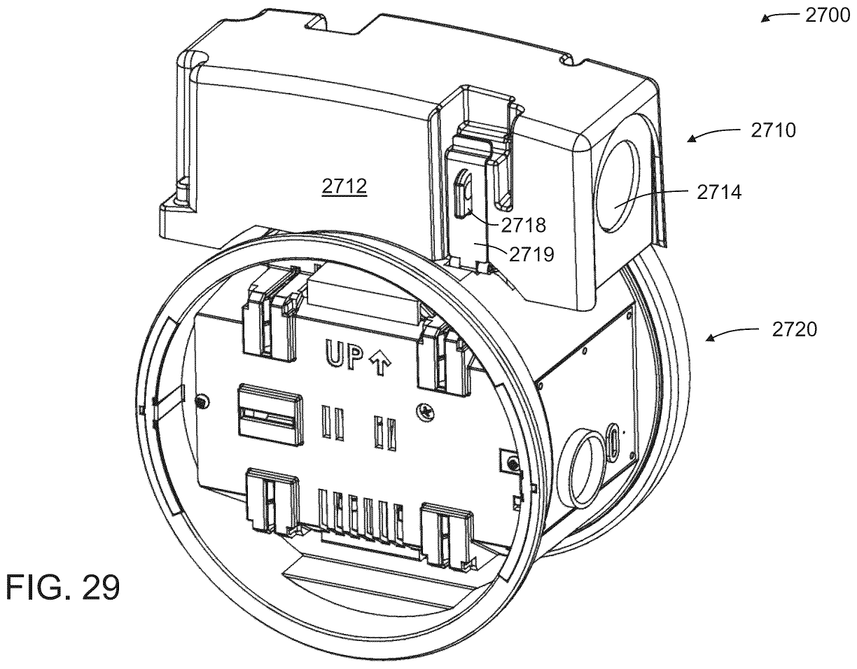

FIG. 29 illustrates an upper perspective view of the system 2700 of FIG. 27 with the pluggable assembly 2710 coupled to the MSA 2720. FIG. 29 shows the hasp hinge 2719 coupled to the hasp eye 2718. In this configuration, a lock, wire, or other locking mechanism can be inserted into the hasp eye 2718 to secure the pluggable assembly 2710 to the MSA 2720. The hasp hinge 2719 may be hingably attached to the MSA 2710 such that the hasp hinge 2719 can be rotated away from the hasp eye 2718 to decouple the hasp hinge 2719 from the hasp eye 2718. In this way, the pluggable assembly 2710 may be secured to the MSA 2720 and removed from the MSA 2720 by moving the hasp hinge 2719, which can be performed without tools.

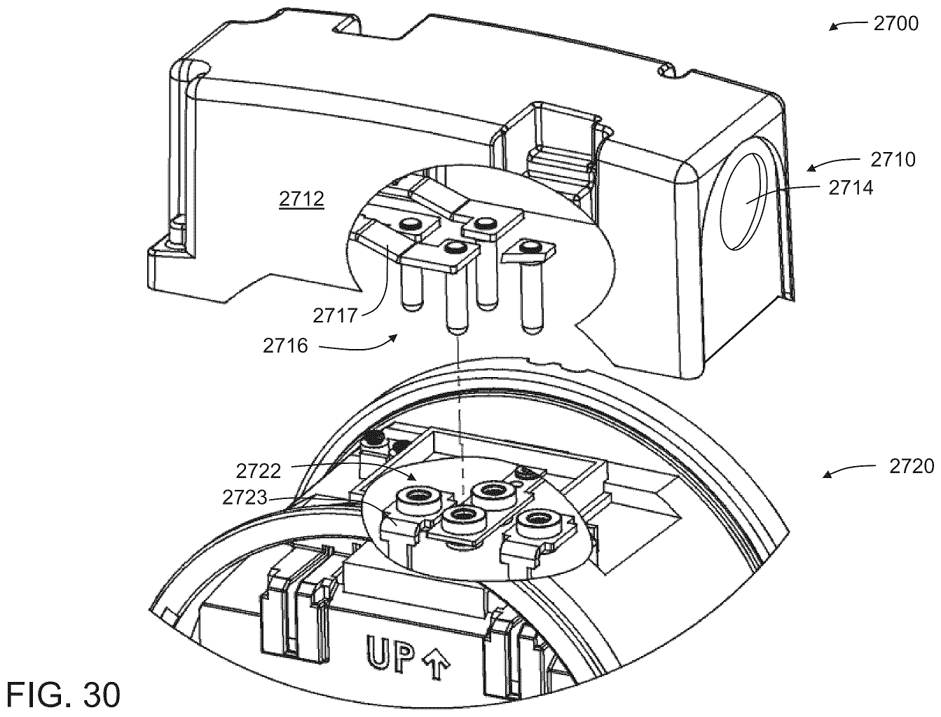

FIG. 30 illustrates a cutaway view of the system 2700 of FIG. 27. The set of power interface connectors 2716 may be connected to electrical components 2717 within the housing 2712 of the pluggable assembly 2710. In an example, the electrical components 2717 are wire terminations which connect to wires of the electrical circuit interface 2714. The set of receptacles 2723 may be connected to electrical components 2723 of the MSA 2720. In an example, the electrical components 2723 of the MSA 2720 are electrically connected to the line-side or service-side terminals of the MSA 2720.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A pluggable assembly to electrically connect a meter socket adapter (MSA) and an electrical circuit, the pluggable assembly comprising:
a housing;
a set of power interface connectors extending from the housing to electrically connect to the MSA;
an electrical circuit interface to electrically connect the set of power interface connectors to the electrical circuit.

2. The pluggable assembly of claim 1, further comprising a data interface connector extending from the housing to electrically connect to the MSA, wherein the data interface connector transmits data between the MSA and external electrical equipment.

3. The pluggable assembly of claim 1, wherein the set of power interface connectors are configured to removably couple the pluggable assembly to the MSA.

4. The pluggable assembly of claim 1, wherein the electrical circuit is electrically connected to a distributed energy resource (DER).

5. The pluggable assembly of claim 1, wherein the set of power interface connectors are symmetrical to allow for the pluggable assembly to be pluggably coupled to the MSA in different orientations.

6. The pluggable assembly of claim 1, wherein the electrical circuit interface includes an electrical conduit.

7. The pluggable assembly of claim 1, wherein the electrical circuit interface includes a circuit breaker within the housing.

8. The pluggable assembly of claim 1, wherein the housing includes one or more of a hasp, clip, or latch for securing the pluggable assembly to the MSA.

9. A pluggable assembly to electrically connect a meter socket adapter (MSA) and a communications circuit, the pluggable assembly comprising:
a housing;
a data interface connector extending from the housing to electrically connect to the MSA; and
a data circuit interface to electrically connect the data interface connector to the communications circuit the data circuit interface to provide load measurements from the MSA to the communications circuit.

10. The pluggable assembly of claim 9, wherein the load measurements include at least one of voltage, current, and power.

11. The pluggable assembly of claim 9, wherein the data circuit interface is configured to provide a control signal from the communications circuit to the MSA to cause the MSA to actuate a switch.

12. The pluggable assembly of claim 9, further comprising a set of metal prongs extending from the housing, the set of metal prongs to pluggably attach the pluggable assembly to the MSA.

13. The pluggable assembly of claim 9, wherein the communications circuit is electrically connected to a distributed energy resource (DER).

14. The pluggable assembly of claim 9, wherein the data interface connector is symmetrical to allow for the pluggable assembly to be pluggably coupled to the MSA in different orientations.

15. The pluggable assembly of claim 9, wherein the housing includes one or more of a hasp, clip, or latch for securing the pluggable assembly to the MSA.

16. A system comprising:
a meter socket adapter (MSA) configured to electrically connect a meter socket and a utility meter, the MSA comprising:
an MSA housing;
electrical contacts to electrically connect the MSA to the meter socket and the utility meter; and
a data circuit to measure an electrical load through the MSA; and
a pluggable assembly configured to be removably coupled to the MSA, the pluggable assembly comprising:
a pluggable assembly housing configured to be coupled to the MSA housing;
at least one of a set of power interface connectors extending from the pluggable assembly housing into the MSA housing to removably connect to the electrical contacts of the MSA and a data interface connector extending from the pluggable assembly housing to removably connect to the data circuit of the MSA; and
at least one of an electrical circuit interface to electrically connect the set of power interface connectors to the electrical circuit and a data circuit interface to electrically connect the data interface connector to the data circuit.

17. The system of claim 16, wherein the electrical circuit is connected to a distributed energy resource (DER).

18. The system of claim 16, wherein the set of power interface connectors and the data interface connector are symmetrical to allow for the pluggable assembly to be removably coupled to the MSA in different orientations.

19. The system of claim 16, wherein the electrical circuit interface includes an electrical conduit, and wherein the data circuit interface includes a wire separate from the electrical conduit.

20. The system of claim 16, wherein the electrical circuit interface includes wire terminations to electrically connect the set of power interface connectors to the electrical circuit.

21. The system of claim 16, wherein the pluggable assembly housing includes one or more of a hasp, clip, or latch for securing the pluggable assembly to the MSA housing.

22. The pluggable assembly of claim 16, wherein the electrical circuit interface is electrical connected to a distributed energy resource (DER), and wherein the communications circuit is electrically connected to the DER.

23. The system of claim 16, further comprising a circuit breaker within the MSA housing or the pluggable assembly housing.
